(19) United States
(12) Patent Application Publication
(10) Pub. No.: US 2026/0339534 A1
(43) Pub. Date: Oct. 29, 2026

(54) SYSTEMS, METHODS, AND DEVICES FOR ACCESSING PARTIAL LOGICAL BLOCKS IN STORAGE DEVICES

(71) Applicant: Samsung Electronics Co., Ltd., Suwon-si (KR)

(72) Inventors: Daniel Lee HELMICK, Erie, CO (US); Javier GONZALEZ, Strand (DK); Klaus JENSEN, Herfolge (DK); Jiwon CHANG, Gyeonggi-do (KR)

(21) Appl. No.: 19/449,405

(22) Filed: Jan. 14, 2026

Related U.S. Application Data
(60) Provisional application No. 63/793,554, filed on Apr. 23, 2025.

(51) Int. Cl. G06F 3/06

(52) U.S. Cl. CPC G06F 3/064; G06F 3/0613; G06F 3/0656; G06F 3/0679

(57) ABSTRACT

A storage device may include at least one storage medium, and at least one control circuit configured to receive, using a storage protocol, an access request, perform, based on the access request, at least one operation including accessing a first partial logical block of data from the at least one storage medium, and accessing a second partial logical block of data from the at least one storage medium, and send, based on the at least one operation, using a transaction of a transport mechanism, the first partial logical block of data and the second partial logical block of data. The at least one operation may include selecting, using a mask, the first partial logical block of data. The access request may include the mask and/or a pointer to the mask. The at least one control circuit may be configured to access the mask using a scatter gather list.

### REFERENCE TO RELATED APPLICATION

This application claims priority to, and the benefit of, U.S. Provisional Patent Application Ser. No. 63/793,554 filed Apr. 23, 2025 which is incorporated by reference.

### TECHNICAL FIELD

This disclosure relates generally to storage systems, and more specifically to systems, methods, and devices for accessing partial logical blocks in storage devices.

### BACKGROUND

A storage protocol may implement write and/or read commands to enable a host to store data at, and/or retrieve data from, a storage device. Data may be stored at a storage device in units of logical blocks which may be accessed using logical block addresses (LBAs).

The above information disclosed in this Background section is only for enhancement of understanding of the background of the inventive principles and therefore it may contain information that does not constitute prior art.

### SUMMARY

A storage device may include at least one storage medium, and at least one control circuit configured to receive, using a storage protocol, an access request, perform, based on the read request, at least one operation including accessing a first partial logical block of data from the at least one storage medium, and accessing a second partial logical block of data from the at least one storage medium, and send, based on the at least one operation, using a transaction of a transport mechanism, the first partial logical block of data and the second partial logical block of data. The at least one operation may include selecting, using a mask, the first partial logical block of data. The read request may include the mask. The read request may include a pointer to the mask. The at least one control circuit may be configured to access the mask using a scatter gather list. The storage device may further include a buffer configured to store the first partial logical block of data and the second partial logical block of data. The at least one control circuit may be configured to send the first partial logical block of data and the second partial logical block of data using a completion queue entry for the read request. The completion queue entry may include the first partial logical block of data. The completion queue entry may include a pointer to the first partial logical block of data. The access request may include a read request. The access request may include a write request. The accessing may include reading. The accessing may include writing.

A method may include receiving, at a storage device, an access request, performing, at the storage device, based on the read request, at least one operation including accessing a first partial logical block of data from at least one storage medium, and accessing a second partial logical block of data from the at least one storage medium, and sending, from the storage device, based on the at least one operation, using a transaction of a transport mechanism, the first partial logical block of data and the second partial logical block of data. The read request identifies a mask, and the accessing a first partial logical block of data may include accessing, using the mask, the first partial logical block of data from the at least one storage medium. The read request may identify a first logical block descriptor and a second logical block descriptor, the accessing the first partial logical block of data may be based on the first logical block descriptor, and the accessing the second partial logical block of data may be based on the second logical block descriptor. The access request may include a read request. The access request may include a write request. The accessing may include reading. The accessing may include writing.

A storage device may include at least one storage medium, and at least one control circuit configured to receive, using a storage protocol, an access request, wherein the read request identifies a first logical block descriptor and a second logical block descriptor, perform, based on the read request, at least one read operation including accessing, using the first logical block descriptor, a first partial logical block of data from the at least one storage medium, and accessing, using the second logical block descriptor, a second partial logical block of data from the at least one storage medium, and send, based on the at least one read operation, the first partial logical block of data and the second partial logical block of data. The first logical block descriptor may include a first logical block address, and the second logical block descriptor may include a second logical block address. The first logical block descriptor may include a first offset, and the second logical block descriptor may include a second offset. The first logical block descriptor may include a first length of data, and the second logical block descriptor may include a second length of data. The read request may include a pointer to a list including the first logical block descriptor and the second logical block descriptor. The read request may include a length of the list. The at least one control circuit may be configured to send the first partial logical block of data and the second partial logical block of data using a scatter gather list, and the scatter gather list may include a portion to identify the first logical block descriptor and the second logical block descriptor. The at least one control circuit may be configured to send the first partial logical block of data and the second partial logical block of data using a transaction of a transport mechanism. The access request may include a read request. The access request may include a write request. The accessing may include reading. The accessing may include writing.

### BRIEF DESCRIPTION OF THE DRAWINGS

The figures are not necessarily drawn to scale and elements of similar structures or functions may generally be represented by like reference numerals or portions thereof for illustrative purposes throughout the figures unless otherwise apparent from context. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1A illustrates an embodiment of an NVMe read command for reading a subsection of a logical block using an SGL in accordance with the disclosure.

FIG. 1B illustrates an embodiment of an SGL segment for reading a subsection of a logical block using an NVMe protocol.

FIG. 1C illustrates an embodiment of a logical block from which a portion of data may be read using an SGL segment for an NVMe protocol in accordance with the disclosure.

FIG. 2 illustrates an embodiment of a storage device and read operation having data aggregation in accordance with the disclosure.

FIG. 3 illustrates an embodiment of a read operation using a mask technique for data selection and/or aggregation in accordance with the disclosure.

FIG. 4 illustrates an example embodiment of a read command including space for mask data to select data in a logical block in accordance with the disclosure.

FIG. 5 illustrates an example embodiment of a read command including a pointer to mask data to select data in a logical block in accordance with the disclosure.

FIG. 6 illustrates another example embodiment of a read command including a pointer to mask data to select data in a logical block in accordance with the disclosure.

FIG. 7 illustrates another example embodiment of a read command including a pointer to mask data to select data in a logical block in accordance with the disclosure.

FIG. 8 illustrates an embodiment of a completion queue entry for a vectored read command in accordance with the disclosure.

FIG. 9 illustrates an embodiment of a completion queue entry including a bitmap to report the status of read and/or selection operations for individual subsections of logical blocks in accordance with the disclosure,

FIG. 10 illustrates an embodiment of a completion queue entry including a pointer to status information to report the status of read and/or selection operations for individual subsections of logical blocks in accordance with the disclosure.

FIG. 11 illustrates an embodiment of a completion queue entry having embedded results for a vectored read command in accordance with the disclosure.

FIG. 12 illustrates an embodiment of a vectored read command using a list of logical block descriptors to identify one or more logical blocks, and/or portions thereof, from which to read data in accordance with the disclosure.

FIG. 13 illustrates an embodiment of a list of logical block descriptors in accordance with the disclosure.

FIG. 14 illustrates an example embodiment of a data aggregation operation in accordance with the disclosure.

FIGS. 15A and 15B illustrate an embodiment of a scheme for reading one or more partial logical blocks using a scatter gather list and a list of logical block addresses in accordance with the disclosure.

FIG. 16 illustrates an example embodiment of a host apparatus that may be used to implement any of the host-side functionality relating to reading, selecting, aggregating, buffering, transferring, and/or the like, partial logical blocks in a storage system including one or more storage devices in accordance with example embodiments of the disclosure.

FIG. 17 illustrates an example embodiment of a storage device that may be used to implement any of the device-side functionality relating to reading, selecting, aggregating, buffering, transferring, and/or the like, partial logical blocks in a storage system including one or more storage devices such as those described herein in accordance with example embodiments of the disclosure.

FIG. 18 illustrates an embodiment of a method for performing a vectored read operation in accordance with the disclosure.

### DETAILED DESCRIPTION

A storage protocol may implement a read command that may specify an LBA within a storage device and an address of a buffer in a host address space. Based on receiving the read command, the storage device may read the data stored in a logical block at the specified LBA and send the data to the host where the data may be stored in the buffer at the specified address in the host address space.

Some read commands may facilitate the reading of a relatively small amount of data (e.g., when the data to be retrieved is smaller than a logical block) by enabling a host to instruct a storage device to only send data from a partial logical block to the host. For example, a storage protocol may implement a read command that uses a scatter gather list (SGL) having one or more segments, each of which may include one or more descriptors such as a bit bucket that may specify a subset of a logical block that the storage device may exclude when sending data from the logical block to the host.

This technique for reading relatively small amounts of data may be inefficient for at least two reasons. First, processing each segment of an SGL may involve retrieving an address of a corresponding host buffer and/or an address of the next segment in the SGL which may consume a relatively large amount of processing overhead at the storage device and/or overhead in a transport mechanism underlying the storage protocol. Second, the relatively small amount of data from each partial logical block specified in each segment and/or descriptor in the SGL may be sent from the storage device to the host using a separate transaction on the underlying transport mechanism. However, each transaction may also consume a relatively large amount of processing overhead at the storage device and/or overhead in the transport mechanism. This relatively high overhead per read command and/or transaction may be especially inefficient in applications such as artificial intelligence (AI) in which a host and/or storage device may perform a relatively large number of read operations on relatively small amounts of data (which may be referred to as small reads, vectored small reads, vectored reads, vector reads, and/or the like).

Some aspects of the disclosure relate to techniques for aggregating portions of data (e.g., partial logical blocks of data) at a host or storage device and transferring the aggregated data to or from a host using fewer transactions than the number of portions of data. For example, in some embodiments in accordance with the disclosure, a storage device may read first and second portions of data from parts of different logical blocks. Additionally, or alternatively, a storage device may read first and second portions of data from different parts of the same logical block. The storage device may aggregate the first and second portions of data in a buffer at the storage device and send the aggregated data to a host using a single transaction of a transport mechanism. Depending on the implementation details, this may reduce overhead, increase efficiency, and/or the like, associated with reading relatively small amounts of data from a storage device.

Some additional aspects of the disclosure relate to techniques for specifying logical blocks and/or portions thereof, from which to read data and/or write data at a storage device. For example, in some embodiments in accordance with the disclosure, a read command for a storage protocol (e.g., a submission queue entry (SQE)) may include a data indicator (e.g., a mask) that may specify one or more portions of one or more logical blocks that may be read by, aggregated at, and/or returned from, a storage device. As another example, in some embodiments in accordance with the disclosure, a read command for a storage protocol may include a location indicator of (e.g., a pointer to) a memory location that may include an indicator (e.g., a mask) that may specify one or more portions of one or more logical blocks that may be read by, aggregated at, and/or returned from, a storage device. In such embodiments, a data indicator, location indicator, and/or the like, may be located at least partially in a data pointer section of an SQE, an unused space of an SQE, and/or the like. Depending on the implementation details, this may reduce overhead, increase efficiency, and/or the like, associated with reading relatively small amounts of data from a storage device.

As a further example, in some embodiments in accordance with the disclosure, a read and/or write command for a storage protocol may include a list of logical block descriptors and/or an indicator of (e.g., a pointer to) a memory location that may include a list of logical block descriptors. A logical block descriptor may include, for example, an LBA, an offset into the logical block at the LBA, and a length of data to be read from the logical block at the specified offset within the logical block. As an additional example, in some embodiments, a read command for a storage protocol may implement an SGL in which an SGL segment may include a type of SGL descriptor that may point to a memory location that may store a list of logical block descriptors that may specify an LBA, an offset into the logical block at the LBA, and a length of data to be read from the logical block at the specified offset within the logical block at the LBA. Depending on the implementation details, any number of these examples of techniques for specifying logical blocks and/or portions thereof, from which to read data at a storage device may reduce overhead, increase efficiency, and/or the like, associated with reading relatively small amounts of data from a storage device.

Some additional aspects of the disclosure relate to techniques for transferring aggregated data from reading and/or writing one or more portions of one or more logical blocks to and/or from a host. For example, in some embodiments, aggregated data from reading one or more portions of one or more logical blocks at a storage device may be returned to a host in a completion queue entry (CQE). Additionally, or alternatively, aggregated data from reading one or more portions of one or more logical blocks at a storage device may be returned to a host by writing it to a buffer at an address indicated (e.g., pointed to) by a read command in an SQE.

Some additional aspects of the disclosure relate to completions for requests to read and/or write relatively small amounts of data to and/or from a storage device. For example, in some embodiments in accordance with the disclosure, a completion for a read command that may specify multiple logical blocks and/or portions thereof from which to read data at a storage device may treat one or more (e.g., all) of the associated read operations collectively (e.g., as an atomic command). Thus, if any of the associated reads of data multiple logical blocks and/or portions thereof fail, a completion for the read command (e.g., a CQE) may indicate an overall failure for the command. As another example, in some embodiments in accordance with the disclosure, a completion for a read command that may specify multiple logical blocks and/or portions thereof from which to read data at a storage device may indicate success or failure of one or more (e.g., each) individual read operation. Thus, a completion for the read command (e.g., a CQE) may indicate whether each associated read operation succeeded or failed.

This disclosure encompasses numerous aspects relating to specifying, aggregating, and/or transferring vectored reads. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as specific interfaces, protocols, and/or the like. For example, some embodiments may be described in the context of a storage system that may use a storage protocol such as Nonvolatile Memory Express (NVMe), and/or one or more storage protocol subsystems, interfaces, and/or the like to transfer data between components using one or more transport mechanisms, interfaces, protocols, and/or the like, such as Peripheral Component Interconnect Express (PCIe), Transmission Control Protocol (TCP), Remote Direct Memory Access (RDMA), and/or the like. However, the aspects of the disclosure are not limited to these or any other implementation details. For example, other storage protocols such as FibreChannel (FC), InfiniBand, Serial ATA (SATA), Small Computer Systems Interface (SCSI), Serial Attached SCSI (SAS), and/or the like, may be used. As another example, embodiments implemented with NVMe may use commands in the form of SQEs that a host may insert into a submission queue and submit to a storage device by providing a doorbell (DB) update to the storage device. The storage device may fetch one or more of the provided SQEs and then parse each SQE to determine the type of command. For example, an opcode (OPC or OpCode) field of 0x01h or 0x02h in an SQE may represent a write command or a read command, respectively, either of which may utilize any aspects of the disclosure. However, aspects of the disclosure may also be used with any other schemes for implementing vectored read commands regardless of the form of the commands, mechanism for transferring (and/or signaling the presence of) commands to a storage device, and/or the like.

In some embodiments, and depending on the implementation details, a transaction may refer to one or more actions by a transport mechanism that may be initiated by a command, request, and/or the like, and may provide end-to-end transmission of a specified amount of data. In some embodiments, a transaction may implement a request-response cycle between a host and a storage device, between a client and a server, and/or the like. For example, a PCIe transaction may take the form of a transaction layer packet (TLP) which may include a header and data payload portion and may or may not be divided into one or more FLITs at a link layer. In some embodiments, and depending on the implementation details, reading data from a storage medium may also refer to reading data from a cache (e.g., volatile memory) or other temporary storage for the storage medium, even if the data is not stored in the storage medium at the time of reading.

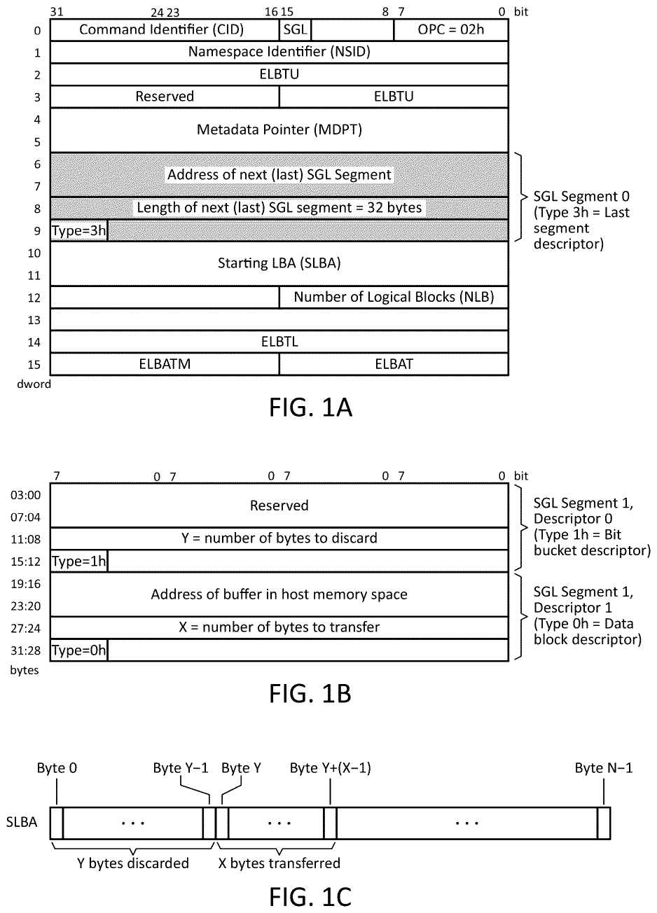

In some contexts, reference indicators having a base portion and a suffix portion may be referred to collectively and/or individually by the base portion. In some contexts, multiple figures having the same numbers with different letter suffixes may be referred to collectively and/or individually by the number. For example, FIGS. 1A-1C may be referred to collectively and/or individually as FIG. 1. In some contexts, as a form of abbreviated notation, a logical block, or the contents of a logical block, may be referred to as an LBA. For example, 128 bytes at the beginning of a logical block at logical block address 0 (LBA 0) may be referred to as the first 128 bytes of LBA 0 or 128 bytes at the beginning of LBA 0.

Some computing workloads such as an inference decode operation of an AI model (e.g., a large language model (LLM)) may read relatively large numbers of vectors (e.g., 100s to 1000s of vectors) of relatively small sizes (e.g., 10s to a few 100s of bytes per vector), sometimes in parallel. In some implementations, a model may reside entirely or partially in one or more storage devices such as solid state drives (SSDs). However, data in a storage device may be read in indirection units (IUs), logical blocks, and/or the like, of 512 bytes (512B), 4 KB, 16 KB, 64 KB, or larger. In some embodiments, data in a storage device may be read in units related to the error correction code (ECC) codeword size. In some embodiments, and depending on the implementation details and/or context, a logical block may refer to a unit (e.g., a smallest unit) of storage media (e.g., nonvolatile memory) that may be accessed (e.g., written and/or read) using a logical address (which, in some embodiments, may be translated to a physical address) such as a logical block, sector, and/or the like.

Thus, if an application running on a host sends a request to read a specific 64B chunk of data from a storage device that is configured for 512B reads (e.g., a 512B logical block size), the storage device may read the 512B logical block in which the specific 64B chunk of data is stored and transfer the entire 512B logical block to the host. The host may then filter the 512B of data to obtain the specific 64B chunk of data requested by the application. This may be referred to as read amplification because the amount of data read (and/or transferred) may be greater than the amount of data requested. Read amplification may result in inefficiencies such as unnecessary power consumption, communication throughput/bandwidth consumption, latency, and/or the like, associated with reading and/or transferring more data than is needed.

A storage system may use a scatter gather list (SGL) to specify a subset of a logical block or blocks to transfer from a storage device to a host, and thus, depending on the implementation details, reduce read amplification. However, as explained below with respect to FIG. 1 and/or Table 1, this may result in a relatively large amount of communication overhead because each vector or other partial logical block of data to be transferred may involve the transmission of a fixed or minimum amount of overhead information (e.g., commands, headers, error checking, and/or the like, at the level of a storage protocol, underlying transport mechanism, and/or the like) regardless of the amount of actual user data that may be specified by each segment and/or descriptor of the SGL.

FIGS. 1A-1C illustrate an embodiment of a scheme for reading a subsection of a logical block using an NVMe protocol to transfer data over a PCIe transport mechanism in accordance with the disclosure. FIG. 1A illustrates an embodiment of an NVMe read command for reading a subsection of a logical block using an SGL in accordance with the disclosure. FIG. 1B illustrates an embodiment of an SGL segment for reading a subsection of a logical block using an NVMe protocol. FIG. 1C illustrates an embodiment of a logical block from which a portion of data may be read using an SGL segment for an NVMe protocol in accordance with the disclosure.

Referring to FIG. 1A, an NVMe read command may include 16 double words (where a double word may be referred to as a dword, a Dword, or a Command Dword (CDW)). Bits 07:00 of Dword 0 may include the opcode 02 h to indicate the command is a read command. Bits 15:14 of Dword 0 may be set to a value (e.g., 01b or 10b) that may indicate that Dword 6 through Dword 9 (which may also be referred to as the Data Pointer (DPTR)) contains the first segment of an SGL that describes a subsection of a logical block to be read and transferred to the host.

In general, with an NVMe read command, data may be read from one or more logical blocks in a storage device beginning at a Starting Logical Block Address (SLBA) contained in Dword 10 and Dword 11 and continuing for the number of logical blocks indicated by the Number of Logical Blocks (NLB) contained in bits 15:00 of Dword 12. In the read operation described with respect to FIG. 1, one logical block may be accessed.

The first SGL segment (Segment 0) contained in Dword 6 through Dword 9 of the NVMe command illustrated in FIG. 1A may include a single 16-byte SGL descriptor of the type SGL Last Segment Descriptor as indicated by code 3 h in bits 27:24 of Dword 9 (which may correspond to bits 07:04 of byte 15 of the SGL descriptor). The SGL descriptor may include an address of the next SGL segment (which in this example may be the last SGL segment) in Dword 6 and Dword 7 (which may correspond to bytes 07:00 of the 16-byte SGL descriptor). The SGL descriptor may include the length of the next SGL segment (which in this example may be the last SGL segment) in Dword 8 (which may correspond to bytes 11:08 of the 16-byte SGL descriptor). In this example, the address of the next SGL segment in Dword 6 and Dword 7 may point to the location of the SGL segment illustrated in FIG. 1B, and the length of the next SGL segment in Dword 8 may be set to 32 which may be the length of the SGL segment illustrated in FIG. 1B.

Referring to FIG. 1B, the next SGL segment (Segment 1) may include a first 16-byte SGL descriptor (Descriptor 0 in bytes 15:00) and a second 16-byte SGL descriptor (Descriptor 1 in bytes 31:16) of the SGL segment.

Descriptor 0 may be of the type Bit Bucket Descriptor as indicated by code 1 h in the type field in bits 07:04 of byte 15 of Descriptor 0. Descriptor 0 may include a value of Y in the length field in bytes 11:08 of Descriptor 0 to indicate that Y bytes should be discarded from the beginning of the logical block at the address SLBA as illustrated in FIG. 1C.

Descriptor 1 may be of the type Data Block Descriptor as indicated by code 0h in the type field in bits 07:04 of byte 15 of Descriptor 1 (which may correspond to byte 31 of the overall SGL segment illustrated in FIG. 1B). Descriptor 1 may include a value of X in the length field in bytes 11:08 of Descriptor 1 (which may correspond to bytes 27:24 of the overall SGL segment illustrated in FIG. 1B) to indicate that X bytes should be read from the logical block at address SLBA starting at an offset Y from the beginning of the logical block, and the X bytes should be transferred to the host as illustrated in FIG. 1C. Descriptor 1 may also include, in the address field in bytes 07:00 of Descriptor 1 (which may correspond to bytes 23:16 of the overall SGL segment illustrated in FIG. 1B), an address of a buffer in a host memory space into which the X bytes should be written.

Thus, in some embodiments, the SGL segment (Segment 1) illustrated in FIG. 1B may instruct a storage device to read an arbitrary number X of bytes starting at an arbitrary offset Y from the beginning of a logical block at address SLBA, and transfer the X bytes to the host.

Referring to FIG. 1C, a logical block of storage media at address SLBA in a storage device may have N bytes (e.g., 512 bytes, 4K bytes, etc.) numbered 0 through N−1. Using the NVMe command illustrated in FIG. 1A and the SGL segment illustrated in FIG. 1B, the storage device may read the logical block at address SLBA, discard the Y bytes at byte 0 through byte Y−1, and transfer the X bytes at byte Y through byte Y+(X−1) to the host.

In some embodiments, the SGL segment illustrated in FIG. 1B may include another descriptor (e.g., a bit bucket descriptor) to indicate that the remaining data at byte Y+X through byte N−1 of the logical block at SLBA may be discarded.

In some embodiments, and depending on the implementation details, the read operation illustrated with respect to FIG. 1 may reduce read amplification by enabling a host to specify a partial logical block for a storage device to read and transfer to the host. However, in some embodiments, and depending on the implementation details, the read operation illustrated with respect to FIG. 1 may result in a relatively large amount of communication overhead.

For example, in a storage system using NVMe to transfer data over a PCIe transport mechanism, each transfer of a partial logical block of data from a storage device to a host, for example, as described with respect to FIG. 1, may use five PCIe transactions as set forth in Table 1. In the example illustrated with respect to Table 1, MemRd refers to an NVMe read command, and MemWr refers to an NVMe write command, and Z refers to the total number of bytes requested by the host (e.g., a partial logical block such as the number X of bytes to transfer in the embodiment illustrated with respect to FIG. 1). Each MemRd and/or MemWr command may use 16 bytes as a header for a direct memory access (DMA) transfer using PCIe.

TABLE 1

| Transac- | | | |
|---|---|---|---|
| tion | | | |
| (TLP) | Command | Purpose | Bytes |
| 1 | Read SQE | Storage device reads NVMe read | 16 |
| | (MemRd) | command from submission queue | |
| 2 | Read SGL | Storage device reads SGL segment | 32 |
| | Segment | to determine portion (e.g., number | |
| | (MemRd) | of bytes) to omit from logical | |
| | | block when transferring user data | |
| | | to host | |
| 3 | Write | Storage device writes user data | 16 + Z |
| | user data | (Z bytes) to location in host | |
| | (MemWr) | memory space specified by SGL | |
| | | segment | |
| 4 | MSI-X | Storage device sends Message | 16 + 4 |
| | Interrupt | Signaled Interrupt to host (16-byte | |
| | (MemWr) | MemWr request (header) plus | |
| | | 4-byte payload) | |
| 5 | Write CQE | Storage device writes completion | 16 + 16 |
| | (MemWr) | entry to completion queue | |
| | | Total | 116 + Z |

For example, if a host requests a 128-byte portion of a logical block (Z=128), the total number of bytes transferred using the five PCIe transactions may be 244. This may determine an estimated overhead for transferring Z bytes from within a logical block.

In some embodiments using PCIe as a transport mechanism, each PCIe transaction may be implemented with a variable-length transaction layer packet (TLP). However, in some embodiments that may use PCIe in FLIT mode (e.g., PCIe 6.0), the FLIT mechanism may introduce additional overhead. For example, a FLIT may have a fixed number of bytes (e.g., 256 bytes) in which protocol TLPs may be transferred. In some situations, a TLP may be split between FLITs to ensure full FLITs are transferred. For example, a TLP for an NVMe memory write command for writing a completion queue entry may be carried in the same FLIT that carries the TLP for an NVMe memory read command for reading the next submission queue entry, physical region page (PRP), or both. However, in some embodiments, 20 bytes of a FLIT may be used for error correction and/or other link-layer purposes, so the number of TLP bytes that may be carried in some FLITs may be 236 bytes. Thus, in some embodiments, transmit (TX) overhead may be calculated using fractions of FLITs (e.g., by multiplying the number of TLP bytes by 256/236). Moreover, in some embodiments, some additional overhead (e.g., one percent) may be added for skip ordered set (SKP OS) control bytes.

In some example embodiments, estimated overhead may be calculated using the following equation:

$$Overhead \approx \frac{( ( T \times \frac{256}{256 - 20} \times 1.01 ) - Z )}{Z} \qquad ( Eq . 1 )$$

where T may represent the total number of transmit bytes involved in the transaction, Z may represent the number of bytes of user data to transfer, 20 may be the number of bytes reserved for DLP, cyclic redundancy check (CRC), ECC, and/or the like, 256 may be the size of a FLIT, and May 1.01 may correspond to one percent SKP OS overhead.

Using the examples of FIG. 1 and/or Table 1, for {T=234, Z=128}, the overhead may be approximately 95 percent. To estimate a minimum overhead with {T=100, Z→0} (e.g., with Z asymptotically approaching, but not reaching, zero to avoid division by zero) the minimum overhead per command may be approximately 9.6 percent.

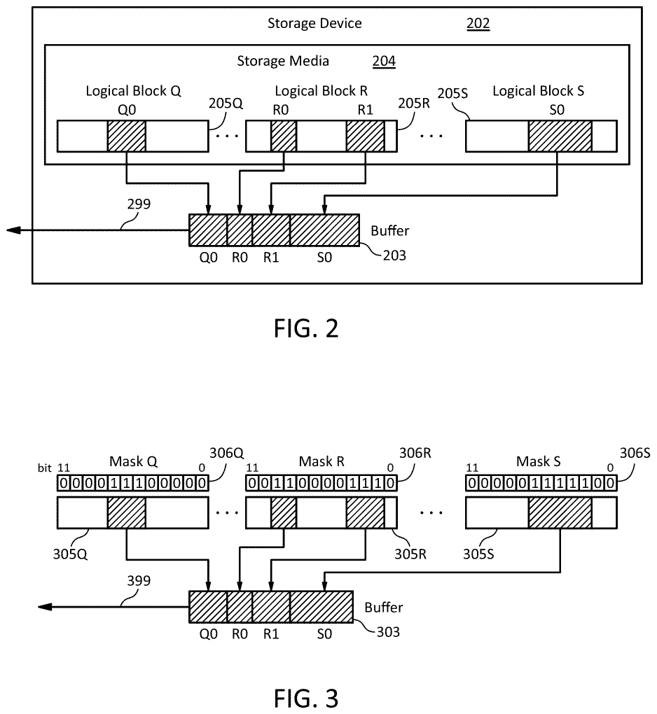

FIG. 2 illustrates an embodiment of a storage device and read operation having data aggregation in accordance with the disclosure. In the embodiment illustrated in FIG. 2, a storage device 202 may read a portion Q0 of logical block Q (indicated as 205Q) in one or more storage media 204 and store Q0 in a buffer 203. Storage device 202 may also read portions R0 and R1 from logical block R (indicated as 205R) in one or more storage media and store R0 and R1 in buffer 203. Storage device 202 may further read portion S0 from logical block S (indicated as 205S) in one or more storage media and store S0 in buffer 203. Thus, partial logical blocks Q0, R0, R1, and/or S0 may be aggregated in buffer 203. This may also be referred to as batching, packing, consolidating, compacting, and/or the like, partial logical blocks.

Storage device 202 may transfer the contents of buffer 203 out of storage device 202 as shown by arrow 299 using fewer transactions of a transport mechanism than the number of partial logical blocks in the buffer. For example, in an embodiment that uses PCIe as a transport mechanism for a storage protocol, storage device 202 may use a single PCIe transaction to transfer Q0, R0, R1, and S0 out of storage device 202 (e.g., to a host).

Depending on the implementation details, aggregating multiple partial logical blocks of data to transfer the data with a reduced number of transactions may reduce communication overhead. For example, in read operation described with respect to Table 1, transferring a subsection of 128 bytes of data (Z=128) from a logical block using PCIe in non-FLIT mode may involve the transmission of 116+128=244 bytes. Thus, the resulting overhead may be about 91 percent (e.g., 116/128=0.91). Depending on the implementation details, performing multiple read operations to transfer multiple partial logical blocks may not change the overhead percentage. For example, transferring four different 128-byte partial logical blocks may involve repeating the five transactions described in Table 1 four separate times, and each read operation may have the same 91 percent overhead.

In contrast, in an example implementation of the read operation illustrated in FIG. 2 in which aggregated partial logical blocks Q0, R0, R1, and S0 are each 128 bytes (and thus Z=512) and transferred using a single Write user data command (Transaction 3) as shown in Table 1, the resulting overhead may be about 23 percent (e.g., 116/512=0.23) (assuming the LBAs, offsets, and/or amounts of data to transfer from each logical block are communicated to storage device 202 using the same number of bytes as the Read SQE command (Transaction 1) and Read SQL command (Transaction 2) shown in Table 1).

The embodiment illustrated in FIG. 2 is not limited to any specific implementation details. For example, the sizes of logical blocks 205Q, 205R, and/or 205S, partial logical blocks Q0, R0, R1, and/or S0, and/or buffer 203 are not limited to any specific values, locations (e.g., location of a logical block within a storage device, location of a subsection within a logical block), and/or the like. As another example, the LBAs, offsets, and/or amounts of data to transfer from each logical block may be communicated to storage device 202 in any suitable manner, for example, using a single command or multiple commands of a storage protocol and/or using one or more data structures and/or techniques, some examples of which may include using one or more masks, using one or more SGL schemes, using one or more LBA descriptors, using one or more data pointers, and/or the like, and/or various combinations thereof, some examples of which are described below. As a further example, buffer 203 may be implemented with a single or multiple buffer structures, or as part of one or more other buffers.

The embodiment illustrated in FIG. 2 is not limited to any specific applications. However, it may be especially beneficial when used in applications such as LLMs. In an LLM application, an inference decode phase of operation may be configured (e.g., optimized) to access vectors from one or more storage devices (e.g., SSDs) using parallelized read requests (e.g., read commands) in which 100s or 1000s of I/O requests for small vector reads from a storage device may be in flight (e.g., pending) in a relatively short time frame (e.g. at the same time). A read operation similar to that illustrated in FIG. 2 may enable a storage device to aggregate read data from some or all of these small vector reads into one or more buffers (e.g., a single buffer) that may include relatively compacted data (e.g., essentially only the vectors requested by an LLM application running at a host) and that may be transferred to a host using a relatively small number of read commands (e.g., a single read command). Depending on the implementation details, this may reduce communication overhead, latency, and/or the like, by increasing the number of small vector reads that may be performed in response to a read command.

FIG. 3 illustrates an embodiment of a read operation using a mask technique for data selection and/or aggregation in accordance with the disclosure. The embodiment illustrated in FIG. 3 may be used, for example, with any storage device and/or read operation disclosed herein including those described with respect to FIG. 2 in which similar elements may be indicated by reference numbers ending in, and/or containing, the same digits, letters, and/or the like.

Referring to FIG. 3, to enable a storage device to select one or more specified portions (e.g., one or more vectors) from one or more logical blocks, a host may send one or more masks 306 along with LBAs of one or more corresponding logical blocks 305. Although mask techniques disclosed herein are not limited to any specific type of mapping between masks and data (e.g., logical blocks), in the embodiment illustrated in FIG. 3, a mask 305 may be implemented as a bit mask in which each bit is mapped to a portion of a corresponding logical block to indicate whether the corresponding portion is to be discarded or transferred (e.g., from a storage device).

For example, in mask Q (indicated as 306Q), bits 7:5 are asserted (e.g., set to logic 1) to indicate that the corresponding portion (indicated as Q0 in buffer 303) of logical block Q (indicated as 305Q) is read and placed in buffer 303, whereas bits 11:8 and 4:0 are deasserted (e.g., cleared to logic 0) to indicated that the corresponding portions of logical block Q are discarded. (In some embodiments, logical block Q (or other indirection unit) may be read in its entirety internally within a storage device, the portion of logical block Q corresponding to the asserted bits in mask Q are placed in buffer 303 for transmission, and the portion of logical block Q corresponding to the bits that are not asserted in mask Q are discarded.)

In mask R (indicated as 306R), bits 9:8 and 3:1 are asserted to indicate that the corresponding portions (indicated as R0 and R1, respectively, in buffer 303) of logical block R (indicated as 305R) are read and placed in buffer 303, whereas bits 11:10, 7:4, and 0 are deasserted to indicate that the corresponding portions of logical block R are discarded. Reading two subsections from within the same logical block may be especially beneficial, for example, in implementations with relatively large IUs where two vectors may be more likely to be located in the same logical block.

In mask S (indicated as 306S), bits 6:2 are asserted to indicate that the corresponding portion (indicated as S0 in buffer 303) of logical block S (indicated as 305S) is read and placed in buffer 303, whereas bits 11:7 and 1:0 are deasserted to indicate that the corresponding portions of logical block S are discarded.

In some other embodiments, any other scheme for the arrangements of masks, bits within masks, corresponding amounts of data (e.g., partial logical blocks), and/or the like, may be used. For example, in some other embodiments, one mask may be used for multiple logical blocks, multiple masks may be used for one logical block, and/or any combination thereof may be used. In some embodiments, a mask may be characterized and/or referred to as a filter that a storage device may apply to a logical block to select the data (e.g., one or more partial logical blocks) requested by a host.

The embodiment illustrated in FIG. 3 may be implemented with one or more masks having any number of bits, and any corresponding number of bytes in a logical block. For example, in some embodiments, a mask having a length of 8 bytes (and therefore 64 bits) may be used to select one or more portions of a logical block having a length of 4096 bytes. Thus, each bit of the mask may correspond to a 64-byte subsection of the logical block, any number of which may be selected to be transferred to a host. For example, a user such as an application running on a host may select the first 128 bytes of a logical block at LBA 0 by providing a mask of H0x03 along with LBA 0. In some embodiments in which a mask 306 may be implemented as a bitmask, each bit may represent a byte range which may be representative of the specific vector. In some embodiments, a byte range per bit may be configured, for example, through a control plane.

In some implementations, the embodiment illustrated in FIG. 3 may use a default logical block granularity (e.g., 512B, 4 KB, 16 KB, 64 KB, or larger) of a storage device with which the data selection and/or aggregation scheme is implemented. In some embodiments, a host or other component may select and/or change a granularity of a storage device.

One or more masks 306 may be sent by a host (e.g., by an application running on a host) along with the LBAs of one or more logical blocks 305 to which the masks 306 may be applied. The masks 306 and/or LBAs may be sent to a storage device, for example, in association with one or more read commands (e.g., one or more SQEs) which a host may place in a submission queue for a storage protocol. In some embodiments, one or more masks 306 and/or one or more corresponding LBAs (which may also refer to pointers thereto) may be characterized and/or referred to as an I/O vector for a read command (e.g., a small vectored read command). In some embodiments, an I/O vector for one or more masks 306 and/or corresponding LBAs (and/or pointers thereto) may be sent to a storage device using one or more data structures and/or techniques, some examples of which may include inserting the I/O vector in one or more fields of a read command (e.g., a DPTR field and/or one or more reserved or redefined fields of an NVMe read command), using one or more SGL schemes, using one or more descriptors, using one or more data pointers, and/or the like, and/or various combinations thereof, some examples of which are described below.

In some embodiments, an I/O vector may have an order of one or more masks 306 and/or one or more corresponding LBAs, and in some embodiments, a storage device may return (e.g., transfer) one or more aggregated results (e.g., one or more requested partial logical blocks) in the same order as the corresponding masks 306 and/or corresponding LBAs in the I/O vector. In some embodiments, any other ordering of I/O vectors and/or results may be used. In some situations, a partial logical block may include an entire logical block, for example, if all of the bits in a mask 306 corresponding logical block 305 happen to be asserted.

In some embodiments, logical blocks identified in an I/O vector for a read command (e.g., logical block Q, logical block R, and/or logical block S) may each be located at any arbitrary addresses within one or more storage media of a storage device. In some other embodiments, one or more logical blocks associated with corresponding masks in an I/O vector may be located at a starting LBA and be arranged sequentially for a number of LBAs.

Although the embodiments illustrated in FIG. 2 and FIG. 3 are not limited to any specific implementation details, some example embodiments, a storage media read (e.g., a NAND page reads) may potentially be 16 KB in size, an ECC codeword may be 4 KB in size, and a logical block may be 512B in size. Such an embodiment may implement a vectored read operation using some or all of the following tasks: (1) a 16 KB page may be read; (2) a 4 KB portion of relevant data within the 16 KB page may be transferred into a controller at the storage device; (3) an ECC may be used to decode the 4 KB portion to correct errors; (4) a mask may be used to identify and/or correct a 512B logical block and/or a desired 64B chunk in the 512B logical block within the 4 KB portion inside the controller to check metadata values (e.g., potentially CRC values for detecting a miscorrection on the ECC decode task); and (5) the 64B chunk may be returned to a host (e.g., using a PCIe link). Depending on the implementation details, beneficial results may be obtained when multiple (e.g., many) of these concurrent small reads are in the system. Thus, fewer commands may be fetched into the drive and/or fewer compacted data transfers may be needed to transfer data out of the drive.

For purposes of illustration, the embodiments illustrated in FIG. 2 and FIG. 3 and/or other drawings may be described in the context of read operations. Aspects of the disclosure, however, may also be implemented with write operations, read-modify-write (RMW) operations, and/or any other type of operations that may aggregate and/or specify partial logical blocks of data. For example, in a write operation in accordance with the disclosure, similar techniques may be used, but one or more data flows may be implemented in reverse.

In some embodiments of a vectored write command, a host may fill one or more data buffers in host memory, and similar LBA indication and/or masking techniques may be used to communicate the vectors to a storage device which may read in the one or more data buffers and apply one or more masks to one or more LBAs mask to write the data into the storage medium at a storage device. Also in some such embodiments, since ECC codewords and/or storage media (e.g., NAND program units) may be relatively large, there may be a possibility of an RMW operation (reading of original data, modifying of a changing portion of the original data, and writing of the complete altered data back to the media). In such an RMW operation, a writing process may include re-encoding, and/or a reading process may include decoding of one or more (e.g., relatively larger) ECC codewords.

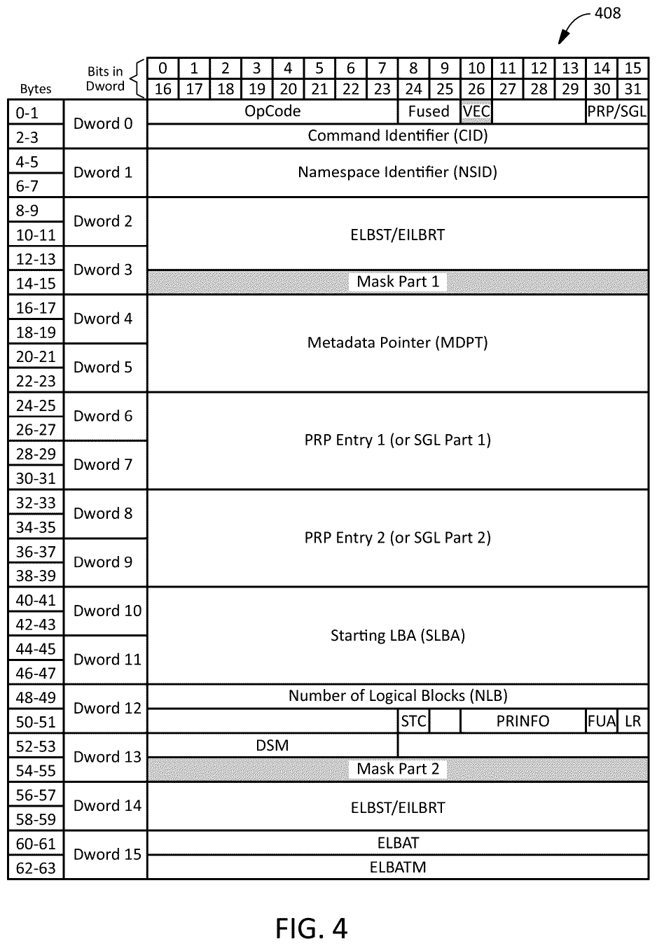

FIG. 4 illustrates an example embodiment of a vectored read command including space for mask data to select data in a logical block in accordance with the disclosure. The embodiment illustrated in FIG. 4 may be used to implement any data selection and/or aggregation scheme disclosed herein, including the schemes described with respect to FIG. 2 and FIG. 3. The embodiment illustrated in FIG. 4 may be described in the context of an NVMe read command used with a PCIe transport mechanism, but the concepts may be applied to any protocol, transport mechanism, and/or the like.

Referring to FIG. 4, a vectored read command 408 (which, for convenience, may be referred to as an SQE since it may be sent to a storage device as an SQE in a submission queue) may include an opcode field (indicated as OpCode in bits 0:7 of Dword 0) into which may be placed a specific opcode that may indicate that read command 408 is a vectored read command. Additionally, or alternatively, read command 408 may have one or more fields (e.g., a single bit field such as bit 10 of Dword 0) that may be asserted to indicate that an opcode for an existing read command is to operate as a vectored read command.

In the example embodiment illustrated in FIG. 4, an I/O vector may be implemented in the form of one or more masks embedded in vectored read command 408, and a starting LBA and number of LBAs for logical blocks in a storage device. For example, four bytes located in bits 16:31 of Dword 3 (Mask part 1) and bits 16:31 of Dword 13 (Mask part 2) may be designated as a mask for a number NLB (bits 15:00 of Dword 12) of consecutive logical blocks at a starting address SLBA (Dword 10 and Dword 11). With a total of 32 bits, the four-byte mask may be used to select portions of any number of logical blocks depending on the number of bytes mapped to each mask bit and the size of a logical block. For example, a 32-bit mask may be used to select 16-byte subsections of a single 512B logical block or 64-byte subsections of four continuous 512B logical blocks. As another example, a 32-bit mask may be used to select 128-byte subsections of a single 4096B logical block or 512-byte subsections of four continuous 4096B logical blocks. That is, the total address space provided for by the block size and NLB may be divided into 32 equal portions, and each portion may be selected by a respective bit of the 32 bits of the mask.

In the example embodiment illustrated in FIG. 4, the partial logical blocks (e.g., the subsections selected by applying the mask to one or more logical blocks indicated by the starting LBA and number of LBAs) may be aggregated (e.g., in a buffer at a storage device) and returned to a host, for example, using a DMA transfer into one or more regions of host memory (e.g., one or more buffers in host memory space) indicated by the DPTR (Dword 6 through Dword 9) in command 408 using one or more PRPs and/or an SGL of which the first segment may be located in Dword 6 through Dword 9.

The four bytes located in bits 16:31 of Dword 3 (Mask part 1) and bits 16:31 of Dword 13 (Mask part 2) are provided as an example of locations in which a mask may be embedded in vectored read command 408. In other embodiments, however, mask data may be embedded in any other locations in vectored read command 408 that may be reserved, available, redefined, and/or the like.

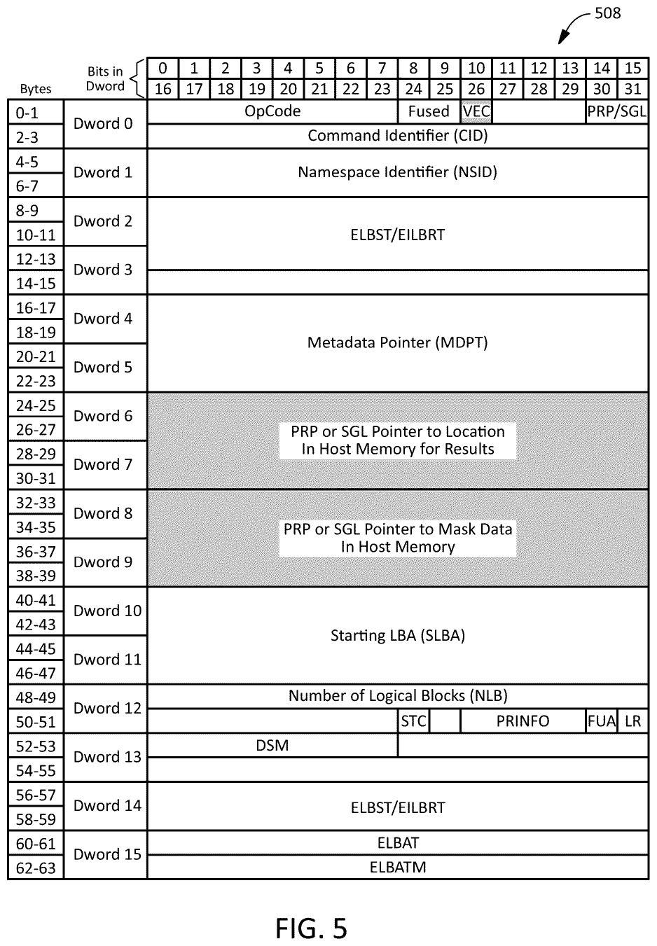

FIG. 5 illustrates an example embodiment of a vectored read command including a pointer to mask data to select data in a logical block in accordance with the disclosure. The embodiment illustrated in FIG. 5 may be used to implement any data selection and/or aggregation scheme disclosed herein, including the schemes described with respect to FIG. 2 and FIG. 3. The embodiment illustrated in FIG. 5 may be described in the context of an NVMe read command used with a PCIe transport mechanism, but the concepts may be applied to any protocol, transport mechanism, and/or the like.

Referring to FIG. 5, a vectored read command 508 may include for an OpCode (bits 0:7 of Dword 0), a vectored read indicator (bit 10 of Dword 0), a starting LBA (Dword 10 and Dword 11), and/or a number of LBAs (bits 0:15 of Dword 12) that may be similar to those described above with respect to FIG. 4. In the embodiment illustrated in FIG. 5, however, a portion of DPTR in Dword 8 and Dword 9 may include a pointer such as a PRP (e.g., a 64-bit pointer) to mask data in host memory. Additionally, or alternatively, Dword 8 and Dword 9 may include a pointer (e.g., a 64-bit pointer) to the first segment of an SGL that may be used to identify the one or more locations in host memory at which mask data may be located.

Although not limited to any specific implementation details, in some embodiments, the mask data located using a pointer (e.g., a PRP and/or an SGL) in Dword 8 and Dword 9 may include enough bytes to filter requested data from a corresponding number of logical blocks indicated by NLB in bits 15:00 in Dword 12. For example, in an implementation in which one 8-byte mask is used to select 64-byte subsections of each corresponding 4096B logical block, and NLB=250, the mask data pointed to by Dword 8 and Dword 9 may include 2000 bytes (e.g., one 8-byte mask for each of the 250 logical blocks). In some embodiments, the mask pointed to on the host may be of any size, and therefore, coupled with the arbitrary size of data provided by the NLB, may allow for any granularity of subsection data selection.

In the embodiment illustrated in FIG. 5, Dword 6 and Dword 7 may include a pointer (e.g., a PRP) that may include the address of a contiguous location in host memory (e.g., a buffer) into which a storage device may write the results of vectored read command 508. Additionally, or alternatively, Dword 6 and Dword 7 may include a pointer to an address of a first segment of an SGL that may be used to identify one or more contiguous locations in host memory (e.g., one or more buffers) into which a storage device may write the results of vectored read command 508. In some embodiments, because a vector read command in accordance with the disclosure may aggregate relatively small amounts of data from partial logical blocks, a location in host memory (e.g., a buffer) into which a storage device may write the results may be a relatively compact and/or contiguous location.

In some embodiments, the PRP/SGL field in bits 14:15 of Dword 0 may be used to indicate whether Dword 6 and Dword 7 point to a buffer in host memory (e.g., a PRP) or the first segment of an SGL in host memory that may be used to determine the location of one or buffers in host memory into which a storage device may transfer the results of vectored read command 508.

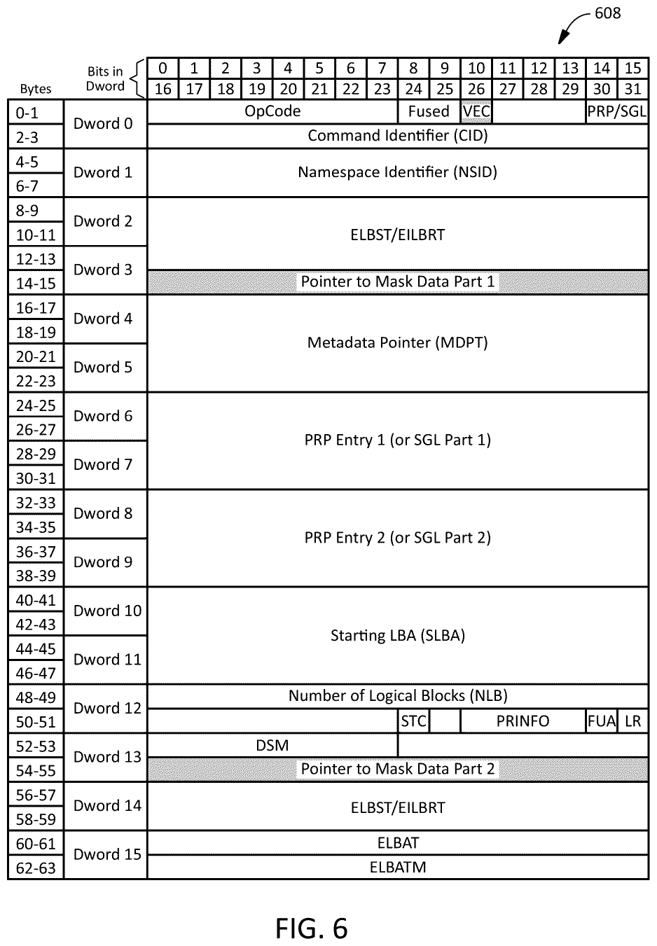

FIG. 6 illustrates another example embodiment of a vectored read command including a pointer to mask data to select data in a logical block in accordance with the disclosure. The embodiment illustrated in FIG. 6 may be used to implement any data selection and/or aggregation scheme disclosed herein, including the schemes described with respect to FIG. 2 and FIG. 3. The embodiment illustrated in FIG. 6 may be described in the context of an NVMe read command used with a PCIe transport mechanism, but the concepts may be applied to any protocol, transport mechanism, and/or the like.

Referring to FIG. 6, a vectored read command 608 may include fields for an OpCode (bits 0:7 of Dword 0), a vectored read indicator (bit 10 of Dword 0), a starting LBA (Dword 10 and Dword 11), and/or a number of LBAs (bits 0:15 of Dword 12) that may be similar to those described above with respect to FIG. 4 and FIG. 5. Additionally, as in the embodiment illustrated in FIG. 4, the DPTR (Dword 6 through Dword 9) in vectored read command 608 may include one or more PRPs and/or the first segment of an SGL which a storage device may use to determine the location(s) of one or more regions of host memory into which it may transfer the results of vectored read command 608.

In the embodiment illustrated in FIG. 6, rather than embedding an actual mask in the four bytes located in bits 16:31 of Dword 3 and bits 16:31 of Dword 13 (or any other locations within vectored read command 608 that may be reserved, available, redefined, and/or the like), the four bytes in vectored read command 608 located in bits 16:31 of Dword 3 (Mask Pointer Part 1) and bits 16:31 of Dword 13 (Mask Pointer Part 2) may include a pointer to the address of mask data that may be used to select subsections of one or more logical blocks indicated by the starting LBA and number of LBAs.

In some embodiments, mask data pointed to by Mask Pointer Part 1 and Mask Pointer Part 2 may have a granularity that may enable a 32-bit pointer to be used in a 64-bit address space. In some embodiments, mask data pointed to by Mask Pointer Part 1 and Mask Pointer Part 2 may have a length that may be a function of the number of logical blocks (NLB) and/or the desired granularity, as discussed above with respect to FIG. 5.

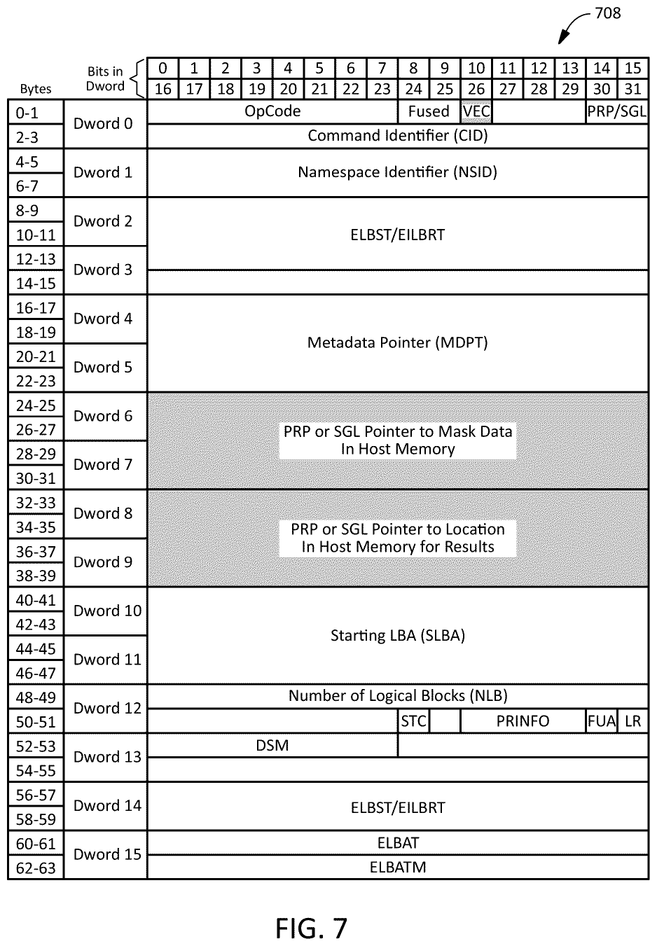

FIG. 7 illustrates another example embodiment of a vectored read command including a pointer to mask data to select data in a logical block in accordance with the disclosure. The embodiment illustrated in FIG. 7 may be used to implement any data selection and/or aggregation scheme disclosed herein, including the schemes described with respect to FIG. 2 and FIG. 3. The embodiment illustrated in FIG. 7 may be described in the context of an NVMe read command used with a PCIe transport mechanism, but the concepts may be applied to any protocol, transport mechanism, and/or the like.

Referring to FIG. 7, a vectored read command 708 may include fields for an OpCode (bits 0:7 of Dword 0), a vectored read indicator (bit 10 of Dword 0), a starting LBA (Dword 10 and Dword 11), and/or a number of LBAs (bits 0:15 of Dword 12) that may be similar to those described above with respect to FIG. 4 and FIG. 5.

In the embodiment illustrated in FIG. 7, however, a portion of DPTR in Dword 6 and Dword 7 may include a pointer (e.g., a 64-bit pointer) to additional information that may be used to execute vectored read command 708. For example, Dword 6 and Dword 7 may point to an address in host memory (e.g., using a PRP and/or an SGL) at which mask data may be located. In some embodiments, this may enable vectored read command 708 to use more mask data than would be able to fit within (e.g., be embedded within) vectored read command 708.

In some embodiments, another portion of DPTR in Dword 8 and Dword 9 may include another pointer (e.g., a 64-bit pointer) to one or more addresses in host memory (e.g., using a PRP and/or an SGL) into which a storage device may transfer the results of vectored read command 708.

Although not limited to any specific implementation details, in some embodiments, mask data located using a pointer (e.g., a PRP and/or an SGL) in Dword 6 and Dword 7 may include enough bytes to filter requested data from a corresponding number of logical blocks indicated by NLB in bits 15:00 in Dword 12. For example, in an implementation in which one 8-byte mask is used to select 64-byte subsections of each corresponding 4096B logical block, and NLB=250, the mask data pointed to by Dword 6 and Dword 7 may include 2000 bytes (e.g., one 8-byte mask for each of the 250 logical blocks). In some embodiments, the mask pointed to on the host may be of any size, and therefore, coupled with the arbitrary size of data provided by the NLB, may allow for any granularity of subsection data selection.

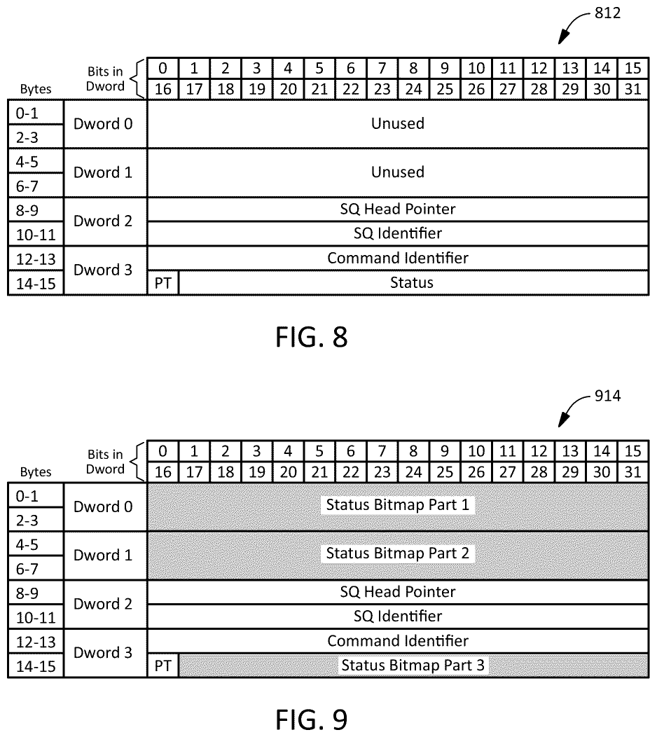

FIG. 8 illustrates an embodiment of a completion queue entry for a vectored read command in accordance with the disclosure. The completion queue entry 812 may be described in the context of an NVMe read command used with a PCIe transport mechanism, but the concepts may be applied to any protocol, transport mechanism, and/or the like.

The completion queue entry 812 illustrated in FIG. 8 may include fields for a submission queue identifier (bits 31:16 of Dword 2), a submission queue head pointer (bits 15:00 of Dword 2), a command identifier (bits 15:00 of Dword 3), a status (bits 31:17 of Dword 3), and/or a phase tag (PT) (bit 16 of Dword 3). Dword 0 and/or Dword 1 may be unused when completion queue entry 812 is used with a read command.

Any of the vectored read commands disclosed herein may be accompanied by a completion which, in some embodiments, may provide information on the status (e.g., success or failure) of the corresponding command. For example, a storage device may place a completion queue entry such as the completion queue entry 812 illustrated in FIG. 8 into a completion queue upon completion of a corresponding vector read command such as those described with respect to FIG. 4, FIG. 5, FIG. 6, and/or FIG. 7 in which the results of the command (e.g., the aggregated partial logical blocks) may be written into one or more data buffers in host memory at one or more locations indicated by a pointer (e.g., a PRP), an SGL, and/or the like. A storage device may place information to indicate the success, failure, and/or other status of a corresponding vectored read command in the status field (e.g., bits 17:31 of Dword 3) of the completion queue entry 812 illustrated in FIG. 8.

A vectored read command in accordance with the disclosure may cause a storage device to perform multiple read operations, for example, to read multiple logical blocks of data from one or more storage media. A read operation of a specific logical block may succeed or fail independently of read operations for other logical blocks. In some embodiments in accordance with the disclosure, the status (e.g., success, failure, and/or the like) of more than one read operation for more than one corresponding logical block may be reported as a single status. For example, in some embodiments, if any one of the read operations for any one of the corresponding logical blocks for a vectored read command fails, the storage device may report the status of the entire vectored read command as failed, even if all of the other read operations for all of the other logical blocks succeeded. In such an embodiment, the storage device may only report the status of the entire vectored read command as successful if all read operations for all of the corresponding logical blocks have succeeded. This may be referred to as treating the command, completion, and/or the like, as atomic, and the status may be referred to as a common status. In such embodiments, the common status may be reported as an error in a status field such as the status field in bits 17:31 of Dword 3 of the completion queue entry 812 illustrated in FIG. 8.

Even in embodiments with common status reporting, however, a host may be provided with some additional information other than just the overall success or failure of the entire vectored read command. For example, in some embodiments, in case of failures in reading and/or selecting more than one partial logical block (which may be referred to as a multi-error), a code (e.g., a dedicated code) that may provide additional information about the failures may be reported to the host. Additionally, or alternatively, a storage device may report the first error occurring in the read and/or selection operations for the subsections of logical blocks identified in the vectored read command. Additionally, or alternatively, a storage device may update a log (e.g., a device log page) with information about one or more specific errors associated with reading and/or selecting individual subsections of logical blocks, and the host may be allowed to query the log to obtain more information about the specific error(s).

In some other embodiments, the status (e.g., success or failure) of one or more (e.g., each) of the reading and/or selecting individual subsections of logical blocks identified in a vectored read command may be reported to a host separately. This may be referred to as treating the command, completion, and/or the like, as non-atomic, and the status may be referred to as individual status. In some embodiments, a completion queue entry may be used to report (e.g., directly in the completion queue entry, indirectly using a pointer such as a DMA pointer, and/or the like) the success or failure of one or more (e.g., each) read and/or selection operation for individual subsections of logical blocks identified in a vectored read command.

FIG. 9 illustrates an embodiment of a completion queue entry including a bitmap to report the status of read and/or selection operations for individual subsections of logical blocks in accordance with the disclosure. The completion queue entry 914 illustrated in FIG. 9 may be used with any of the storage devices, read and/or selection operations, vectored read commands, and/or the like, disclosed herein, including those illustrated in FIGS. 2 through 7. Completion queue entry 914 may be described in the context of an NVMe read command used with a PCIe transport mechanism, but the concepts may be applied to any protocol, transport mechanism, and/or the like. Completion queue entry 914 illustrated in FIG. 9 may include fields for an SQ identifier, an SQ queue head pointer, a command identifier, a status, and/or a phase tag (PT) that may be similar to those used in completion queue entry 812 illustrated in FIG. 8.

Referring to FIG. 9, completion queue entry 914 may include one or more status bitmaps in which bits may indicate the status (e.g., success or failure) of corresponding read and/or selection operations for individual subsections of logical blocks identified in a vectored read command. In the example illustrated in FIG. 9, completion queue entry 914 may include a status bitmap in Dword 0 (Status Bitmap 1) and/or Dword 1 (Status Bitmap 2). Additionally, or alternatively, in some embodiments, some or all of the status bitmap (e.g., Status Bitmap 3) may be located in the status field in bits 17:31 of Dword 3 of completion queue entry 914. In some embodiments, each bit of the status bitmap may indicate the success or failure status of a read and/or selection operation of a corresponding partial logical block identified in a vectored read command. The number of bits in the status bitmap may be determined by the number of partial logical blocks that may be supported by a corresponding vectored read command. Additionally, or alternatively, a storage device may maintain a log that may provide additional information about specific errors for each failed read and/or selection operation of a partial logical block. A host may access the log to determine the additional error information for a failed operation.

For purposes of illustration, in the embodiment illustrated in FIG. 9, a total of 79 bits available for reporting. Thus, the total number of small reads (e.g., vectors) that may be reported may be 79, in which case, each of the small reads may have its own status represented in the CQE. In some embodiments, each bit may represent 64B of read data (or any other predetermined (e.g., hard decided) size). If there are several small reads of 8B each, then eight of those small reads may be grouped together and be assigned the same status. If any of the eight fail, then all eight may be marked as a failure. The host may then resend the 64B and figure out which ones of the eight failed and move forward from there. Additionally, or alternatively, if the small reads are 128B in size, then the single bits representing 64B may optionally be used to report different behaviors for different sections of the 64B that include the total 128B. In some such implementation, 79 bits may enable reporting the status of 64*79 bytes of total data read.

In some embodiments (e.g., using a CQE to return read data as described below with respect to FIG. 11), multiple CQEs may be used together to return more individual statuses (e.g., using more than 79 bits). Some embodiments may predict one status for each of the submitted SQEs, and this one status will fail if any of the component reads fail.

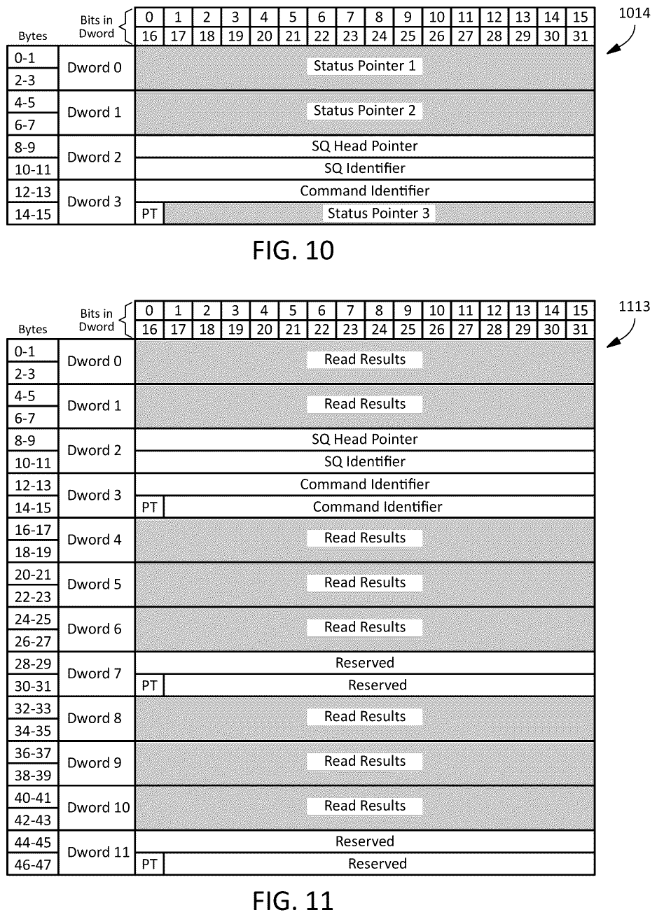

FIG. 10 illustrates an embodiment of a completion queue entry including a pointer to status information to report the status of read and/or selection operations for individual subsections of logical blocks in accordance with the disclosure. The completion queue entry 1014 illustrated in FIG. 10 may be used with any of the storage devices, read and/or selection operations, vectored read commands, and/or the like, disclosed herein, including those illustrated in FIGS. 2 through 7. Completion queue entry 1014 may be described in the context of an NVMe read command used with a PCIe transport mechanism, but the concepts may be applied to any protocol, transport mechanism, and/or the like. Completion queue entry 1014 illustrated in FIG. 10 may include fields for an SQ identifier, an SQ queue head pointer, a command identifier, a status, and/or a phase tag that may be similar to those used in completion queue entry 812 illustrated in FIG. 8.

Referring to FIG. 10, completion queue entry 1014 may include one or more status pointers in Dword 0 (Status Pointer 1) and/or Dword 1 (Status Pointer 2). Additionally, or alternatively, in some embodiments, some or all of a status pointer (e.g., Status Pointer 3) may be located in the status field in bits 17:31 of Dword 3 of completion queue entry 1014. A status pointer (e.g., a DMA pointer) may point to one or more locations in host memory at which a storage device may write information such as a bitmap, a list of statuses (e.g., success or failure) and/or corresponding error information, and/or the like, for one or more (e.g., each) read and/or selection operation for individual subsections of logical blocks associated with a vectored read command. In such embodiments in which the status information may include one or more status bit maps, each bit of a status bitmap may indicate the success or failure status of a read and/or selection operation of a corresponding partial logical block identified in a vectored read command. The number of bits in a status bitmap may be determined by the number of partial logical blocks that may be supported by a corresponding vectored read command.

In some embodiments, a storage device may write status information to one or more locations in host memory pointed to by an SQE for a vectored read command to report the status of read and/or selection operations for individual subsections of logical blocks in accordance with the disclosure. For example, in the vectored read commands illustrated in FIGS. 5 through 7, any buffer in host memory for results data pointed to by a PRP, SGL, and/or the like, may include additional space that may be designated for a storage device to return a list of statuses (e.g., success or failure) and/or corresponding error information, and/or the like, for one or more (e.g., each) read and/or selection operation for individual subsections of logical blocks associated with a vectored read command.

In some embodiments of schemes for data selection and/or aggregation in accordance with the disclosure, at least a portion of the results may be returned to a host within a completion queue entry. Depending on the implementation details, this may reduce overhead associated with a vectored read command, for example, by reducing or eliminating data transfers associated with one or more storage protocol commands and/or transactions of a transport mechanism such as the write user data command (Transaction 3) listed in Table 1.

FIG. 11 illustrates an embodiment of a completion queue entry having embedded results for a vectored read command in accordance with the disclosure. The embodiment illustrated in FIG. 11 may be used to implement any data selection and/or aggregation scheme disclosed herein, including the schemes described with respect to FIGS. 2 through 7. The embodiment illustrated in FIG. 11 may be described in the context of an NVMe read command used with a PCIe transport mechanism, but the concepts may be applied to any protocol, transport mechanism, and/or the like.

Referring to FIG. 11, completion queue entry 1113 may include fields for a submission queue identifier (bits 31:16 of Dword 2), a submission queue head pointer (bits 15:00 of Dword 2), a command identifier (bits 15:00 of Dword 3), a status (bits 31:17 of Dword 3), and/or a phase tag (bit 16 of Dword 3) similar to those in the completion queue entry 812 illustrated in FIG. 8.

In completion queue entry 1113, however, Dword 0 and/or Dword 1 may be used to return read results to a host. Thus, a storage device may place aggregated data from reading one or more portions of one or more logical blocks using an I/O vector (e.g., one or more masks and/or information to locate one or more corresponding logical blocks). Additionally, or alternatively, in some embodiments, some or all of the return read results placed in completion queue entry 1113 may be in the form of a pointer to return read results.

Depending on the implementation details, returning read results in completion queue entry 1113 may reduce overhead associated with a vectored read command, for example, by reducing or eliminating data transfers associated with one or more storage protocol commands and/or transactions of a transport mechanism. For example, the write user data command (Transaction 3) listed in Table 1 may be eliminated because some or all of the result data may be returned in completion queue entry 1113, and therefore, the write user data command may not be used. Additionally, or alternatively, returning read results in completion queue entry 1113 may eliminate the use of a read SGL segment command (Transaction 2) listed in Table 1 because there may be no need to provide an address of a buffer in host memory.

In some embodiments, completion queue entry 1113 may end at Dword 3 and thus occupy the same amount of space as the completion queue entry 812 illustrated in FIG. 8, while still providing eight bytes of space for result data from a vectored read command. In some other embodiments, however, completion queue entry 1113 may include one or more additional fields that may be used to transfer results of a vectored read command to a host. For purposes of illustration, completion queue entry 1113 is shown with a total of 12 Dwords occupying 48 bytes, but any amount of additional space for returning read results to a host may be used. In the example illustrated in FIG. 11, additional read results may be transferred in completion queue entry 1113 using Dword 4, Dword 5, Dword 6, Dword 8, Dword 9, and/or Dword 10.

In some embodiments, one or more Dwords falling on 16-byte boundaries may be configured to preserve the structure of the 16-byte completion queue entry 812 illustrated in FIG. 8. For example, bits 31:17 and 15:00 of Dword 7 may be reserved, and bit 17 of Dword 7 may be designated as a phase tag. Depending on the implementation details, this may enable hardware at a host and/or storage device to reuse a phase tag mechanism and/or maintain wrapping operation of a completion queue which may be implemented as a first-in-first-out (FIFO) queue.

Additionally, or alternatively, that status field at bits 31:17 of Dword 3 may include information to enable a host to determine a length of completion queue entry 1113. For example, the status field may report the number of additional 16-byte sections that may follow the first 16-byte section that includes Dword 0, Dword 1, Dword 2, and Dword 3. Additionally, or alternatively, a field anywhere within completion queue entry 1113 (e.g., at the end of Dword 3) may indicate that the specific 16-byte section in which it is included may be the last 16-byte section of completion queue entry 1113. Some embodiments may use this type of entry-elongation approach to send longer status bitmaps which, depending on the implementation details, may reduce or eliminate one or more issues with the embodiment described above with respect to FIG. 9.

In some embodiments, it may be implicit in a vectored read command that some or all the result data returned in response to the read command may be embedded in a completion queue entry. Additionally, or alternatively, a vectored read command may include a field to indicate that some or all the result data returned in response to the read command may be embedded in a completion queue entry.

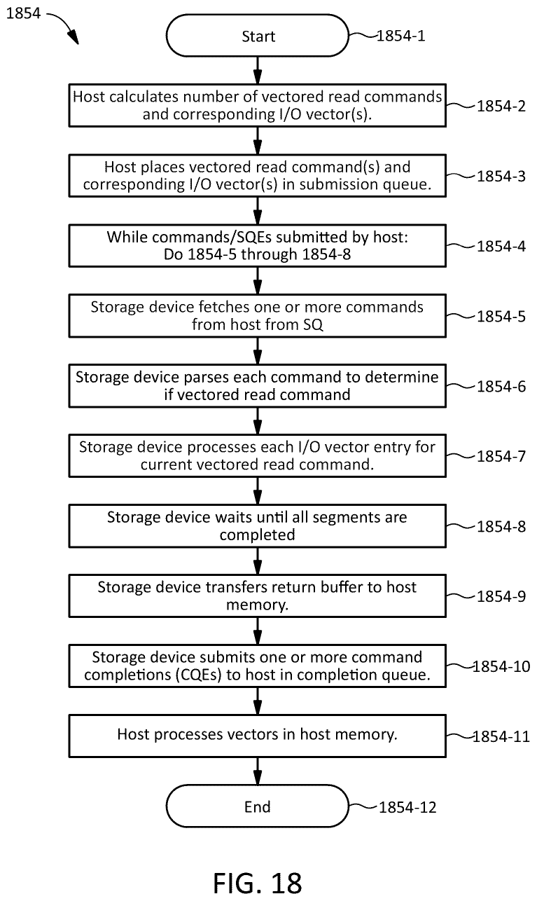

FIG. 18 illustrates an embodiment of a method for performing a vectored read operation in accordance with the disclosure. For purposes of illustration, the 1854 is described below in the context of an LLM running on a host and using the techniques described herein in accordance with example embodiments of the disclosure (e.g., with respect to at least FIGS. 2 through 11) to a relatively large number of vectors from a storage device in a parallelized manner using an NVMe protocol with an underlying PCIe transport mechanism. The techniques described herein, however, are not limited to these or any other implementation details. Moreover, for purposes of illustrating aspects of the disclosure, the operations illustrated in FIG. 18 may assume the host is only submitting vectored read commands to the storage device. In some embodiments, however, a host may submit other types of commands to a storage device in addition to vectored read commands, and the other types of commands may be processed in parallel with, interleaved with, in sequence with, and/or the like, the vectored read commands discussed with respect to FIG. 18. The operations illustrated in FIG. 18 are example operations, and in some embodiments, some operations may be omitted and/or other operations may be included. Moreover, in some embodiments, the temporal order of the operations may be varied.

Referring to FIG. 18, method 1854 may begin at operation 1854-1. At operation 1854-2, based on techniques disclosed herein for parallelizing the inference decode phase, a host (which may run an application such as an LLM) may calculate the number of vectored read commands and/or I/O vectors for each command to optimize the latency and/or throughput trade-off for this phase. Based on these considerations, the host may decide to send, for example, eight read commands (which may be referred to as C0-C7), each having a corresponding I/O Vector with 100 entries and with data sizes (e.g., size of a partial logical block) ranging from 64 bytes to 512 bytes. Thus, commands C0-C7 may request a total of 800 partial logical blocks of data. In some embodiments, commands C0-C7 may operate in parallel in a storage device that supports parallel commands. The processing flow of commands proceed as follows.

At operation 1854-3, the host may place the vectored read commands in a submission queue. Each command may be accompanied by an I/O vector that may include information to identify 100 partial logical blocks (e.g., using the SLBA and/or NLB fields of the command) and corresponding mask information for the 100 partial logical blocks. For example, the mask data may include an 8-byte bitmask for each logical block and may be located in host memory at one or more addresses pointed to by a PRP located in one or both of Dword 6 and Dword 7 or Dword 8 and Dword 9 of the vectored read command. Alternatively, the mask data may be located in host memory at one or more addresses identified in an SGL having a first segment located in Dword 6 through Dword 9 of the vectored read command. If each logical block includes only a single chunk of data requested by the host, the I/O vector may include a total of 100 LBAs and 100 corresponding 8-byte bit masks. However, if some logical blocks include multiple chunks of data (e.g., as illustrated with respect to logical block R indicated as 205R in FIGS. 2 and 305R in FIG. 3), the I/O vector may include less than 100 LBAs and less than 100 corresponding bitmasks (i.e., fewer bitmasks, but with more selections per mask).

At operation 1854-4, the storage device may a run a constant check for new SQEs from the host, and while commands/SQEs are submitted by the host, the device may perform one or more of operations 1854-5 through 1854-8 described below.

At operation 1854-5, the storage device may fetch one or more commands which the host may have placed as SQEs in a submission queue. In some embodiments, the storage device may process vectored read command (e.g., in the form of SQEs) in the order in which the commands appear in the submission queue.

At operation 1854-6, the storage device may parse each command to determine if it is a vectored read command and, if so, process each I/O vector entry for the current vectored read command as shown at operation 1854-7. In some embodiments, the storage device may process each entry of the I/O vector(s) (e.g., each logical block at a specified LBA and a corresponding bitmask) for the current vectored read command in the order in which the entries are arranged in the I/O vector. The storage device may process each logical block at the lowest granularity that may still accommodate the largest partial logical block (e.g., subsection of a logical block) specified in the I/O vector. For example, if all requested partial logical blocks are less than 512B in size, the storage device may transform all logical block reads to 512B reads of the storage media in the storage device. The size of the largest partial logical block may be determined, for example, by scanning the mask data to find the longest consecutive run of asserted bits. Each internal read of a 512B logical block may be referred to as an internal I/O. As the storage device completes each internal I/O for a command, the corresponding mask may be applied to select the requested data from one or more subsections of the logical block(s). The selected data (which may range in size, for example, from 64 to 512 bytes) may be placed in a return buffer within the storage device in the order determined by the order of each LBA and corresponding bitmask in the I/O vector. Examples of return buffers include buffer 203 illustrated in FIG. 2 and/or buffer 303 illustrated in FIG. 3.

In some embodiments, any of all of operations 1854-6 through 1854-7 may be performed by the storage device in parallel, for example, for increased or maximum concurrency as may be possible with available resources at the storage device. Moreover, in some embodiments, operations 1854-6 through 1854-7 may be implemented at least in part, as follows:

the storage device may fetch a vectored read command into the device, parse through the command, and initiate internal read operations from the storage media (e.g., NAND memory) for the I/O vector entries. As each of the vectors is read (potentially out of order) the storage device may track the segments until they are all complete as shown at operation 1854-8.

At operation 1854-9, the storage device may transfer the contents of a return buffer to host memory using any of various techniques. For example, in some embodiments, the storage device may wait until a buffer of some minimum size (e.g., 4 KB) is entirely or mostly filled (e.g., full and contiguous). In some embodiments, the storage device may not wait until all of the read data is in the return buffer ready to transfer to the host. In some embodiments, the storage device may monitor (e.g., using an inner loop) for all of the associated pieces of data in the return buffer to be ready before performing the transfer to the host. In some embodiments, the storage device may transfer the return buffer to the host, for example, by writing the return buffer to a buffer in host memory (e.g., using a DMA write) at a location determined as described above with respect to FIGS. 9 and/or 10.

At operation 1854-10, the storage device may submit one or more command completions (CQEs) to the host, for example, in a completion queue. In some embodiments, a status (e.g., success or failure) of each internal I/O and/or selection operation may be updated in a bitmap or other data structure in a completion queue entry and/or a buffer pointed to by a completion queue entry or submission queue entry. In some embodiments, the storage device may update a log with more detailed error information about each failed internal I/O and/or selection operation. Alternatively, a status of each internal I/O and/or selection operation may be used to generate a common status for the entire vectored read command (e.g., success may be reported only if all internal I/Os in the I/O vector are successful).

At operation 1854-11, upon being notified of one or more completions (e.g., by a completion queue doorbell register, interrupt, and/or the like) the host may process the vectors (e.g., partial logical blocks) in the buffer in host memory in the same order in which the corresponding entries were placed in the I/O vector. The method may end at operation 1854-12.

Although the method illustrated in FIG. 18 is not limited to any specific implementation details, in some possible example embodiments, one read command may be sent representing multiple LBAs, and inside of each of the LBAs the same mask offset may be applied for the read of each of the multiple (e.g., many) LBAs. Such an embodiment may implement one or more of the following tasks: (1) a host may store data in a storage device in a repeating format, for example, 1-3 MB objects where a leading header of an object may contain metadata of interest in a repeating offset (e.g., the data of interest may be the initial input source type of this object, it may be 8B in size, and it may be located at offset 32B into the object); (2) the host may send one or more read commands according to the above format with a repeating mask applied to one or more (e.g., all) of the objects (e.g., to read all of the LBAs at the common offset and send all of the aggregated data back to a buffer at the host); and (3) the host may parse through the returned data and determine the objects to fully completely read out of the drive.

Depending on the implementation details, the LLM vectored read operations described above may reduce the amount of data transferred from the storage device to the LLM at least because, for example, without the data selection and/or aggregation techniques in accordance with the disclosure, the storage device may have transferred up to 100 logical blocks, each including 512 bytes of data to the LLM rather than just one or more subsections of the logical blocks as described above. Moreover, without the data selection and/or aggregation techniques in accordance with the disclosure, transferring the individual partial logical blocks may have involved additional overhead associated with the use of an individual read command with the accompanying transactions (e.g., five transactions per read command as illustrated in Table 1) for each of the up to 100 logical blocks. Additionally, the LLM may have performed the data selection operation on each of the logical blocks to obtain the requested subsection of the logical block. Thus, in some embodiments, and depending on the implementation details, some or all of the techniques disclosed herein may be referred to, and/or characterized as, offloading the filtering, masking, selection, and/or the like, to the storage device.

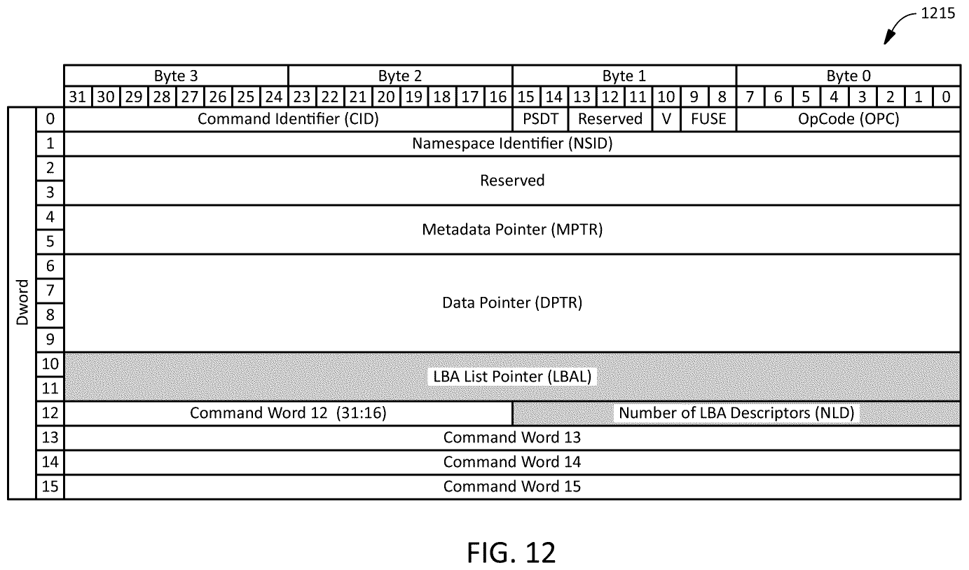

FIG. 12 illustrates an embodiment of a vectored read command using a list of logical block descriptors to identify one or more logical blocks, and/or portions thereof, from which to read data in accordance with the disclosure. The vectored read command 1215 may be used to implement, or may be implemented with, any of the schemes for data aggregation including those described with respect to FIGS. 2-11. Vectored read command 1215 illustrated in FIG. 12 may be described in the context of an NVMe read command used with a PCIe transport mechanism, but the concepts may be applied to any protocol, transport mechanism, and/or the like. Vectored read command 1215 may include one or more fields similar to those described above with respect to FIGS. 4 through 7 including fields for an OpCode (bits 0:7 of Dword 0) and a vectored read indicator (bit 10 of Dword 0).

Referring to FIG. 12, vectored read command 1215 may include one or more fields that may enable a storage device to access one or more logical block descriptors that may identify one or more partial logical blocks that a storage device may return in response to vectored read command 1215. For example, vectored read command 1215 may include a pointer (e.g., a 64-bit pointer) in Dword 10 and Dword 11 to a list of logical block descriptors. For convenience, a logical block descriptor may be referred to as an LBA descriptor, and a list of logical block descriptors may be referred to as a logical block list or an LBA list. Thus, the pointer in Dword 10 and Dword 11 may be referred to as an LBA list pointer (LBAL).

Vectored read command 1215 may also include, for example, in bits 15:00 of Dword 12, a number of logical blocks in the LBA list pointed to by Dword 10 and Dword 11. For convenience, the number of logical blocks may be referred to as a number of LBA descriptors (NLD).

In the vectored read command 1215 illustrated in FIG. 12, the fields for LBA list pointer (LBAL) and number of LBA descriptors (NLD) may take the place of the fields for a starting logical block address (SLBA) and number of logical blocks (NLB), respectively, in other embodiments of a read command.

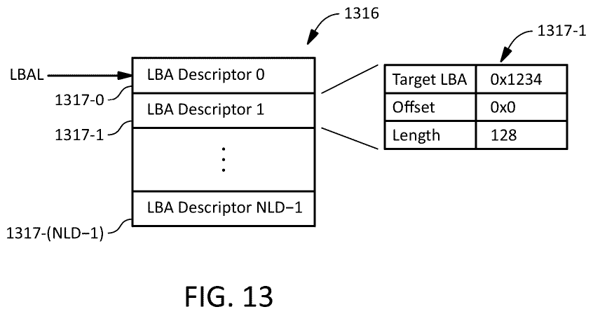

FIG. 13 illustrates an embodiment of a list of logical block descriptors in accordance with the disclosure. The list of logical block descriptors (LBA list) 1316 may include one or more logical block descriptors 1317-0, 1317-1, . . . , 1317-(NLD−1). The LBA list 1316 may be located in host memory, for example, at a starting address pointed to by LBAL in vectored read command 1215 (illustrated in FIG. 12) and continuing for an amount of memory determined by NLB. For example, in an embodiment in which each logical block descriptor 1317 includes 16 bytes, LBA list 1316 may occupy 16*NLD bytes. In other embodiments, however, logical block descriptors 1317 may be implemented with any number of bytes, and in some embodiments, one or more logical block descriptors 1317 may have a variable number of bytes.

In some embodiments, one or more (e.g., each) of logical block descriptors 1317 may include any number of fields to specify one or more subsections of a logical block from which data may be read. In FIG. 13, logical block descriptor 1317-1 is shown in an enlarged form to illustrate some example fields such as those described in Table 2.

TABLE 2
Logical Block Descriptor

| Bytes | Label | Purpose |
|---|---|---|
| 07:00 | Target LBA | This field specifies a 64-bit address of the |
| | (TLBA) | target logical block described by this |
| | | descriptor. |
| 11:08 | Offset (OFF) | This field specifies a byte offset into the |
| | | target logical block indicated by TLBA. |
| 15:12 | Length (LEN) | This field specifies the number of bytes |
| | | to read from the target logical block |
| | | beginning after the offset. |

The field labeled as Target LBA (TLBA) may specify an address of a target logical block from which one or more subsections may be read. In this example, a TLBA may have 64 bits, but in other embodiments, any suitable number of bits may be used based on a logical block address space (e.g., a contiguous memory area) within a storage device.

The field labeled as Offset (OFF) may specify an offset (e.g., in number of bytes) into the target logical block. In embodiments in which a logical block is the smallest addressable unit within a storage device (e.g., a logical block must be read in its entirety), the number of bytes indicated by OFF may be discarded after the logical block is read.

The field labeled as Length (LEN) may specify a number of bytes, beginning after the last byte of the offset, that may be read from the target logical block and transferred, for example, to a host that issued vector read command 1215 (illustrated in FIG. 12). Thus, the offset and length fields may specify the location of a subsection of data within the target logical block (e.g., a partial logical block).

In the embodiments illustrated with respect to FIG. 13 and Table 2, each logical block descriptor 1317 may have the same size (e.g., number of bytes such as 16) and/or number of fields. In other embodiments, however, one or more logical block descriptors may have a different number of fields, length in bytes, and/or the like. For example, in some embodiments, a logical block descriptor may include an additional offset field and an additional length field that may specify the location of a second subsection data within the target logical block (e.g., a second partial logical block within the target logical block). In such an embodiment, a logical block descriptor may include a field, a flag, and/or the like, to indicate the number of offsets and/or lengths, and therefore, additional subsections within the target logical block that may be read and returned to a host.

The logical block descriptors 1317 in LBA list 1316 may be processed by a storage device in any suitable order, and the resulting partial logical blocks may be returned to a host in any suitable manner. In some embodiments, however, logical block descriptors 1317 in LBA list 1316 may be processed in the order in which they appear in LBA list 1316. Additionally, or alternatively, the resulting partial logical blocks obtained by processing logical block descriptors 1317 may be returned to a host in the order in which they appear in LBA list 1316. For example, as each logical block descriptor 1317 is processed, the one or more resulting sections of logical blocks (e.g., partial logical blocks) may be placed in a return buffer (e.g., similar to buffer 203 illustrated in FIG. 2 and/or buffer 303 illustrated in FIG. 3) that may be transferred to a host, for example, using a single transaction after the last logical block descriptor 1317-(NLD−1) has been processed. In some embodiments, a storage device may transfer a return buffer to a host, for example, by writing the return buffer contents to a host memory location using a DMA write transaction on a PCIe transport mechanism.

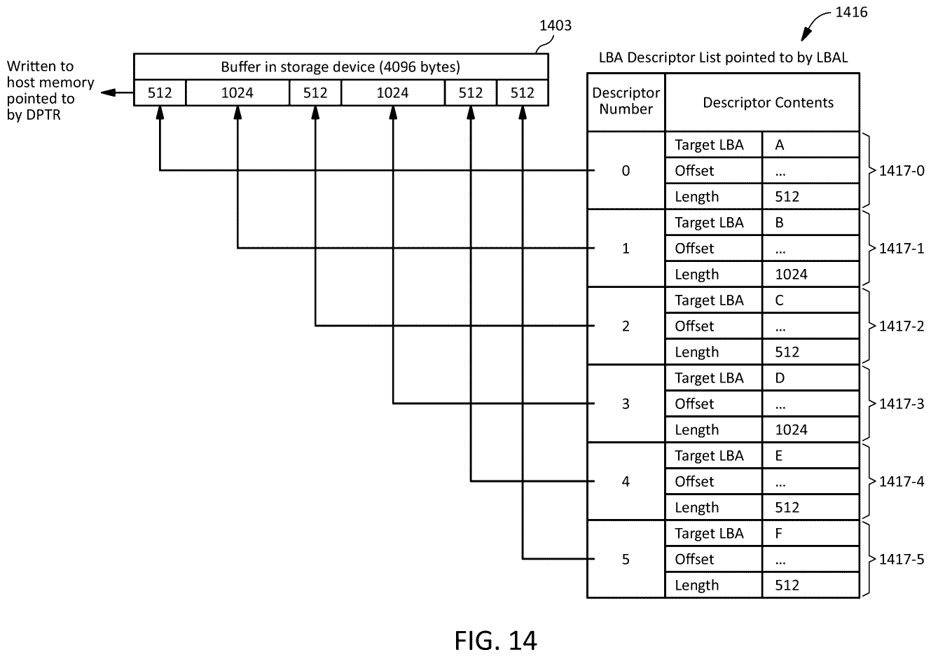

FIG. 14 illustrates an example embodiment of a data aggregation operation in accordance with the disclosure. The operation illustrated in FIG. 14 may be used, for example, to implement, or be implemented with, the vectored read command 1215 illustrated in FIG. 12 and/or the LBA list 1316 illustrated in FIG. 13.

Referring to FIG. 14, an LBA list 1416 may include six LBA descriptors 1417-0, . . . , 1417-5. Thus, if LBA list 1416 is used with vectored read command 1215 illustrated in FIG. 12, NLD may be equal to six. A storage device may process the LBA descriptors 1417 starting at the top of LBA list 1416 and place the resulting partial logical blocks read from the corresponding target logical blocks in return buffer 1403 in the order of the LBA descriptors 1417 in LBA list 1416.

The TLBAs shown in LBA descriptors 1417 are indicated as A, . . . , F to indicate arbitrary addresses within a logical block address space in a storage device. The offsets shown in LBA descriptors 1417 are shown with ellipses to indicate arbitrary offsets within each corresponding target logical block. The lengths of the resulting partial logical blocks read from the corresponding target logical blocks are provided in LBA descriptors 1417 and are reflected in corresponding amounts of space occupied by the resulting partial logical blocks in return buffer 1403.

After processing the last LBA descriptor 1417-5, a storage device may transfer return buffer 1403 to a buffer in host memory space identified by DPTR (Dword 6 through Dword 9) in vectored read command 1215 (e.g., using a PRP, SGL, and/or the like) illustrated in FIG. 12.

In some embodiments, one or more aspects of the disclosure relating to logical block descriptors may be combined with one or more other aspects of the disclosure relating to scatter gather lists. For example, referring to any of the schemes that may use an SGL as described with respect to FIGS. 1, 5, 6, and/or 7, one or more logical block descriptors and/or an LBA list may be integrated with an SGL.

For example, in some embodiments, an SGL segment may include an LBA list type of SGL descriptor that may include a pointer to an LBA list in host memory. The LBA list type of SGL descriptor may be the last descriptor in the SGL segment, or the LBA list type of SGL descriptor may be followed in the SGL segment by any other type of SGL descriptor. Depending on the implementation details, this may cause a vectored read command using an SGL to appear to be a normal read command using an SGL.

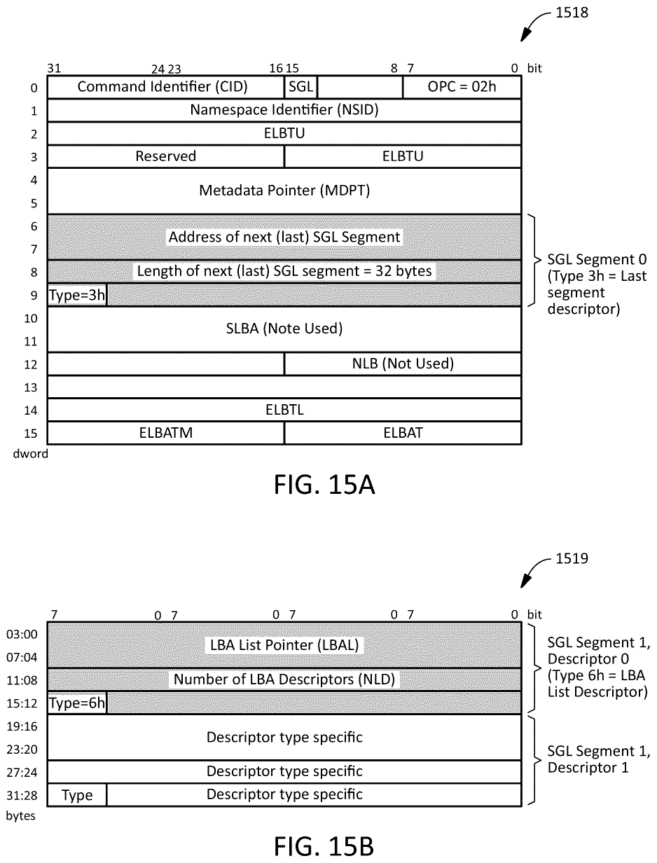

FIG. 15 illustrates an embodiment of a scheme for reading one or more partial logical blocks using a scatter gather list and a list of logical block addresses in accordance with the disclosure. FIG. 15A illustrates an embodiment of a vectored read command using a scatter gather list and a list of logical block addresses in accordance with the disclosure. FIG. 15B illustrates an embodiment of a segment of a scatter gather list having a descriptor with a pointer to a list of logical block addresses in accordance with the disclosure.

Referring to FIG. 15A, vectored read command 1518 may include some elements that may be the same as the read command illustrated in FIG. 1A. For example, the first SGL segment (Segment 0) contained in Dword 6 through Dword 9 of vectored read command 1518 may include a 16-byte SGL descriptor of the type SGL Last Segment Descriptor as indicated by the code 3 h in bits 27:24 of Dword 9 (which may correspond to bits 07:04 of byte 15 of the SGL descriptor). The address of the next SGL segment in Dword 6 and Dword 7 may point to the next SGL Segment 1519 (Segment 1) illustrated in FIG. 15B.

Referring to FIG. 15B, the first 16-byte descriptor (Descriptor 0) in Segment 1 may be implemented as an LBA list type of SGL descriptor as indicated by the code 6 h in bits 27:24 of Dword 9 (which may correspond to bits 07:04 of byte 15 of the SGL descriptor).

Descriptor 0 may include, in an address field in bytes 07:00 of Descriptor 0 (which may correspond to bytes 07:00 of the overall SGL segment 1519 illustrated in FIG. 15B), an address (LBAL) that points to a location in host memory in which an LBA list may be stored.

Descriptor 0 may also include, in a field in bytes 11:08 of Descriptor 0 (which may correspond to bytes 11:08 of the overall SGL segment 1519 illustrated in FIG. 15B), a length (NLD) of the LBA list stored at the address LBAL.

Descriptor 0 may be the only descriptor in Segment 1, or Descriptor 0 may be followed by one or more additional descriptors such as Descriptor 1 as illustrated in FIG. 15. For purposes of illustration Descriptor 1 of Segment 1 is shown generically as an SGL descriptor with no specific type, but Descriptor 1 may be implemented as any type of SGL descriptor and used for any purpose that any other type of SGL descriptor may be used.

The LBA list stored at the address LBAL pointed to by Descriptor 0 and having a length NLD may be implemented, for example, with an LBA list similar to LBA list 1316 illustrated in FIG. 13 and may include, for example, one or more LBA descriptors such as LBA descriptors 1317 illustrated in FIG. 13.

The LBA list stored at the address LBAL pointed to by Descriptor 0 and having a length NLD may be used by a storage device to read one or more partial logical blocks, for example, in a manner similar to that described with respect to FIGS. 12 through 14.

In some embodiments, although vectored read command 1518 may include a starting LBA field (SLBA) in Dword 10 and Dword 11 and a number of logical blocks field (NLB) in bits 15:00 of Dword 12, depending on the implementation details, the SLBA and/or NLB fields may not be used, for example, because a storage device may use the LBA list at the address LBAL pointed to by Descriptor 0 of segment 1519 as an I/O vector to identify the partial logical blocks to read for vectored read command 1518.

In some additional embodiments in accordance with the disclosure, a data pointer such as DPTR (Dword 6 through Dword 9) illustrated in FIGS. 4, 5, 6, 7, and/or 12 may be used for schemes to select and/or aggregate data from partial logical blocks in a storage device. For example, in some embodiments, a data pointer may be used in accordance with a specification such as NVMe, but with the additional feature of placing data contiguously following one or more PRPs, SGLs, and/or the like. As another example, in some embodiments, a data pointer may be used in accordance with a specification such as NVMe, but with the additional feature of implementing one or more offsets. For example, one or more offsets may be sized to fit data in one or more pages of host memory. In some embodiments, and depending on the implementation details, this may reduce interrupts, data routing at a host, and/or the like, for example, because different pages may trigger one or more interrupts on various host components.

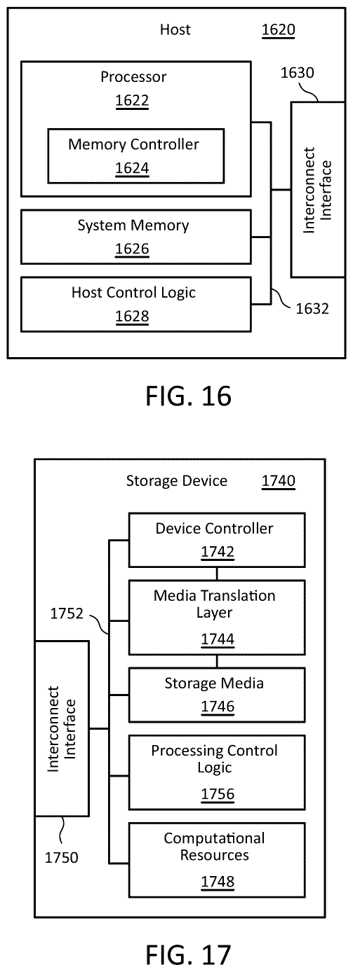

FIG. 16 illustrates an example embodiment of a host apparatus that may be used to implement any of the host-side functionality relating to reading, selecting, aggregating, buffering, transferring, and/or the like, partial logical blocks in a storage system including one or more storage devices in accordance with example embodiments of the disclosure. The host apparatus 1620 illustrated in FIG. 16 may include a processor 1622, which may include a memory controller 1624, a host system memory 1626, host control logic 1628, and/or an interconnect interface 1630, which may be implemented, for example, using one or more storage protocols, transport mechanisms, and/or the like. Any or all of the components illustrated in FIG. 16 may communicate through one or more system buses 1632. In some embodiments, one or more of the components illustrated in FIG. 16 may be implemented using other components. For example, in some embodiments, the host control logic 1628 may be implemented by the processor 1622 executing instructions stored in the system memory 1626 or other memory.

FIG. 17 illustrates an example embodiment of a storage device that may be used to implement any of the device-side functionality relating to reading, selecting, aggregating, buffering, transferring, and/or the like, partial logical blocks in a storage system including one or more storage devices such as those described herein in accordance with example embodiments of the disclosure. The storage device 1740 may include a device controller 1742, a media translation layer 1744, a storage media 1746, computational resources 1748, processing control logic 1756, and an interconnect interface 1750. The components illustrated in FIG. 17 may communicate through one or more device buses 1752. In some embodiments that may use flash memory for some or all of the storage media 1746, the media translation layer 1744 may be implemented partially or entirely as a flash translation layer (FTL).

Any of the functionality disclosed herein including any of the host functionality, storage device functionality, and/or the like, may be implemented with hardware, software, and/or a combination thereof including combinational logic, sequential logic, one or more timers, counters, registers, and/or state machines, one or more complex programmable logic devices (CPLDs), field programmable gate arrays (FPGAs), application specific integrated circuits (ASICs), central processing units (CPUs) such as complex instruction set computer (CISC) processors such as x86 processors and/or reduced instruction set computer (RISC) processors such as ARM processors, graphics processing units (GPUs), neural processing units (NPUs), tensor processing units (TPUs) and/or the like, executing instructions stored in any type of memory, or any combination thereof. In some embodiments, one or more components may be implemented as a system-on-chip (SOC), system-in-package (SIP), and/or the like. In some embodiments, and depending on the context, the terms logic, circuit, device, and/or the like, may be used interchangeably.

In the embodiments disclosed herein, some storage protocols and/or underlying transport mechanisms may be implemented as a layer of a stack at a host, a storage device, and/or the like, to enable the storage protocol to be used with more than one underlying transport mechanism. For example, a storage protocol such as Nonvolatile Memory Express (NVMe) may implement read and/or write commands that may be used with more than one underlying transport mechanism such as Peripheral Component Interconnect Express (PCIe), Transmission Control Protocol (TCP), Remote Direct Memory Access (RDMA), and/or the like.

Any of the hosts disclosed herein may be implemented with any component or combination of components including one or more of a client device, a server, a storage node, a CPU, a personal computer, a tablet computer, a smartphone, and/or the like.

Any of the storage devices disclosed herein may be implemented with any storage media such as magnetic media (e.g., a hard disk drive (HDD) or a tape drive), solid state media (e.g., one or more flash memory devices), optical media, and/or the like. For instance, in some embodiments, a storage device may be implemented at least partially as a solid state drive (SSD) based on not-AND (NAND) flash memory, persistent memory (PMEM) such as cross-gridded nonvolatile memory, memory with bulk resistance change, phase change memory (PCM), or any combination thereof.

Any of the storage devices disclosed herein may be implemented in any storage device (e.g., storage drive) form factor such as 3.5 inch drive, 2.5 inch drive, 1.8 inch drive, M.2 drive, Enterprise and Data Center Standard Form Factor (EDSFF), NF1, and/or the like, using any connector configuration such as Serial ATA (SATA), Small Computer System Interface (SCSI), Serial Attached SCSI (SAS), U.2 (SFF-8639), U.3, and/or the like. Any of the storage devices disclosed herein may be implemented entirely or partially with, and/or used in connection with, a server chassis, server rack, dataroom, datacenter, edge datacenter, mobile edge datacenter, and/or any combinations thereof.

Any of the communication connections, interfaces, protocols, fabrics, frameworks, controllers, functions, endpoints, and/or the like, disclosed herein may be implemented, for example, with PCIe, NVMe, NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel (FC), InfiniBand, Serial ATA (SATA), Small Computer Systems Interface (SCSI), Serial Attached SCSI (SAS), iWARP, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced extensible Interface (AXI), any generation of wireless network including 2G, 3G, 4G, 5G, 6G, and/or the like, any generation of Wi-Fi, Bluetooth, near-field communication (NFC), and/or the like, or any combination thereof.

Although the concepts disclosed herein are not limited to any specific applications, they may be especially beneficial when applied to any number of the following fields of use.

Some SSD deployments may target different storage layers. One storage layer may be a cache layer. In some embodiments, caching SSDs may support 1000s of millions of I/O operations per second (thousands of MIOPS) at high device writes per day (DWPD). In some embodiments, a typical indirection unit (IU) for an SSD may be 4 KB. For example, a PCIe Gen5 SSD may be able to provide ~30 MIOPs using 512B reads at 3-5 DWPD.

Another storage layer may be capacity and/or archive layers. Colder SSDs used for capacity and/or archive layers may typically be less expensive but slower and have lower DWPD. SSD used for these layers may use larger I/Os, and throughput may generally be more important than IOPS. The IU in these SSDs may generally be larger such as 16 KB, 64 KB, and larger. Larger IUs may be used, for example, with larger drive capacities, especially for archive layers.

For larger capacity SSDs, indirection units (IUs) larger than the standard 4 KB may be beneficial (e.g., 16 KB, 64 KB). While 512B reads may still be supported, there may be a penalty in transferring data at lower granularities such as 512B.

AI inference workloads may be challenging for storage devices such as SSDs having these I/O and/or capacity characteristics. Moreover, larger AI models, for cost purposes, may reside entirely or partially in storage devices such as SSDs rather than being loaded in volatile memory such as dynamic random access memory (DRAM) (e.g., all at once). In some embodiments, some augmentation may be based on models that reside on SSDs and/or are accessed by inference accelerators (e.g., GPUs, ASICs) on demand. In inference stages of AI operation (prefix and/or decode), 100s to 1000s of vectors (of sizes ranging from 10s to a few 100s of bytes) may be accessed in parallel. This may be achieved by different parallelization techniques developed for LLMs and may result in 100s to 1000s of parallel small reads using, for example, the smallest read sizes available. Even with relatively smaller read sizes such as 512B logical blocks, the amount of data transferred from a storage device to a host may be far greater than the data actually needed, and thus, a relatively large amount of data (e.g., much larger than the needed data) may be is transferred to a host then be filtered in the host in order to obtain the actual vector needed by the application (e.g., 64 bytes out of a 512-byte logical block read at a storage device and transferred to the host. This may result in read amplification. Similar problems may be encountered with database applications as well.

With larger LLM models, SSDs may be used as the main media for storing a model during inference operations may increase, for example, to reduce costs. In some embodiments, storage I/O operations may be driven (e.g., directly) from an accelerator to an SSD. Vector sizes, however, may generally be relatively small. Moreover, with larger LLM models, the number of vectors and/or associated structures for models (e.g., dimensions, layers, and/or the like) may generally become larger. This may result in more vectors being read during a decode phase. Depending on the implementation details, this may increase read amplification for AI inference workloads. This, in turn, may reduce effective throughput and/or increase latency of LLMs which may impose limitations on the size scalability of LLMs.

One possible approach to these issues associated with the SSD deployments described above may involve reducing the LBA read granularity. However, transfers between a host and a storage device with transfer sizes lower than 512B may be relatively inefficient. In embodiments that may transfer data using NVMe, transfers may involve SQ Entries (e.g., 64B) and/or CQ Entries (e.g., 16B) for each command which may result in relatively high overhead. For example, to transfer 128 bytes of data, the ratio of metadata to data may reduce the efficiency of the communication link. Moreover, additional host compute cycles to create and/or process each individual SQE and/or CQE may make it inefficient to reduce LBA sizes.

However, one or more aspects of the disclosure relating to accessing, selecting, aggregating, buffering, transferring, and/or the like, partial logical blocks in a storage system including one or more storage devices such as those described herein in accordance with example embodiments of the disclosure may reduce or solve any number of the issues associated with the SSD deployments described above. For example, some embodiments may provide one or more methods to perform small reads to the host without (i) wasting transport bandwidth due to read amplification, (ii) incurring a performance penalty due to a relatively high ratio between transferred data and metadata, and/or (iii) incurring multiple host processor interrupts and/or processing per CQE. As another example, embodiments disclosed herein may provide vectored I/Os (e.g., read operations) that may improve I/O efficiency and reduce read amplification. As a further example, embodiments disclosed herein may provide methods of describing a list of LBA subsections within a single vectored read command. As yet another example, embodiments disclosed herein may provide methods of transferring one or more logical block subsections, for example, consecutively and/or with respect to their position in an LBA List.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific components, processes, operations, etc., but these terms also encompass embodiments in which a specific component, process, operation, etc. may be implemented with multiple components, processes, operations, etc., or in which multiple components, processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

1. A storage device comprising:
at least one storage medium; and
at least one control circuit configured to:
receive, using a storage protocol, an access request;
perform, based on the access request, at least one operation comprising:
accessing a first partial logical block of data from the at least one storage medium; and
accessing a second partial logical block of data from the at least one storage medium; and
send, based on the at least one operation, using a transaction of a transport mechanism, the first partial logical block of data and the second partial logical block of data.

2. The storage device of claim 1, wherein the at least one operation comprises selecting, using a mask, the first partial logical block of data.

3. The storage device of claim 2, wherein the access request comprises the mask.

4. The storage device of claim 2, wherein the access request comprises a pointer to the mask.

5. The storage device of claim 2, wherein the at least one control circuit is configured to access the mask using a scatter gather list.

6. The storage device of claim 1, further comprising a buffer configured to store the first partial logical block of data and the second partial logical block of data.

7. The storage device of claim 1, wherein the at least one control circuit is configured to send the first partial logical block of data and the second partial logical block of data using information within a completion queue entry for the access request.

8. The storage device of claim 7, wherein the information within the completion queue entry comprises the first partial logical block of data.

9. The storage device of claim 7, wherein the information within the completion queue entry comprises a pointer to the first partial logical block of data.

10. A method comprising:
receiving, at a storage device, an access request;
performing, at the storage device, based on the access request, at least one operation comprising:
accessing a first partial logical block of data from at least one storage medium; and
accessing a second partial logical block of data from the at least one storage medium; and
sending, from the storage device, based on the at least one operation, using a transaction of a transport mechanism, the first partial logical block of data and the second partial logical block of data.

11. The method of claim 10, wherein;
the access request identifies a mask; and
the accessing a first partial logical block of data comprises accessing, using the mask, the first partial logical block of data from the at least one storage medium.

12. The method of claim 10, wherein:
the access request identifies a first logical block descriptor and a second logical block descriptor;
the accessing the first partial logical block of data is based on the first logical block descriptor; and
the accessing the second partial logical block of data is based on the second logical block descriptor.

13. A storage device comprising:
at least one storage medium; and
at least one control circuit configured to:
receive, using a storage protocol, an access request, wherein the access request identifies a first logical block descriptor and a second logical block descriptor;
perform, based on the access request, at least one access operation comprising:
accessing, using the first logical block descriptor, a first partial logical block of data from the at least one storage medium; and
accessing, using the second logical block descriptor, a second partial logical block of data from the at least one storage medium; and
send, based on the at least one access operation, the first partial logical block of data and the second partial logical block of data.

14. The storage device of claim 13, wherein:
the first logical block descriptor comprises a first logical block address; and
the second logical block descriptor comprises a second logical block address.

15. The storage device of claim 13, wherein:
the first logical block descriptor comprises a first offset; and
the second logical block descriptor comprises a second offset.

16. The storage device of claim 13, wherein:
the first logical block descriptor comprises a first length of data; and
the second logical block descriptor comprises a second length of data.

17. The storage device of claim 13, wherein the access request comprises a pointer to a list comprising the first logical block descriptor and the second logical block descriptor.

18. The storage device of claim 17, wherein the access request comprises a length of the list.

19. The storage device of claim 13, wherein:
the at least one control circuit is configured to send the first partial logical block of data and the second partial logical block of data using a scatter gather list; and
the scatter gather list comprises a portion to identify the first logical block descriptor and the second logical block descriptor.

20. The storage device of claim 13, wherein the at least one control circuit is configured to send the first partial logical block of data and the second partial logical block of data using a transaction of a transport mechanism.
